(19) United States
(12) Patent Application Publication
(10) Pub. No.: US 2025/0213989 A1
(43) Pub. Date: Jul. 3, 2025

(54) A COMPUTER SOFTWARE MODULE ARRANGEMENT, A CIRCUITRY ARRANGEMENT, AN ARRANGEMENT AND A METHOD FOR PROVIDING A VIRTUAL DISPLAY FOR SIMULTANEOUS DISPLAY OF REPRESENTATIONS OF REAL LIFE OBJECTS AT DIFFERENT PHYSICAL LOCATIONS

(71) Applicant: Telefonaktiebolaget LM Ericsson (publ), Stockholm (SE)

(72) Inventors: Saeed BASTANI, Dalby (SE); Fredrik DAHLGREN, Lund (SE); Yun LI, Lund (SE); Andreas KRISTENSSON, Södra Sandby (SE); Alexander HUNT, Tygelsjö (SE)

(21) Appl. No.: 18/850,280

(22) PCT Filed: Mar. 30, 2022
(86) PCT No.: PCT/EP2022/058399

§ 371 Date: Sep. 24, 2024

(51) Int. Cl. A63F 13/803; A63F 13/216; A63F 13/25; A63F 13/655

(52) U.S. Cl. CPC A63F 13/803; A63F 13/216; A63F 13/25; A63F 13/655

(57) ABSTRACT

A virtual display arrangement comprising a display device, a communication interface and a controller, wherein the communication interface is configured to connect with a first remote-controlled vehicle, the controller is configured to receive user input and to control the first remote-controlled vehicle based on the user input along a track, and the display device is configured to show the first remote-controlled vehicle being navigated based on the user input along the track, wherein the communication interface is further configured to connect with a second virtual display arrangement controlling a second remote-controlled vehicle along a second track, and wherein the controller is configured to: receive information relating to navigation of the second remote-controlled vehicle along the second track, display a graphical representation of the second remote-controlled vehicle in the display device at a position relative the first remote-controlled vehicle on the track corresponding to a position of the second remote-controlled vehicle on the second track.

### TECHNICAL FIELD

The present invention relates to an arrangement, an arrangement comprising computer software modules, an arrangement comprising circuits, a device and a method for providing a virtual display for simultaneous display of representations of real life objects at different physical locations.

### BACKGROUND

Displays are used for providing visual information or content, such as computer or otherwise generated visual content, i.e. virtual content. One example of a display used to display virtual content is head-mounted displays (HMD), which can be either in the form of virtual reality (VR) headsets, augmented reality (AR) headsets, or mixed reality (MR) headsets. In a VR headset, only the generated content is shown. There are variants of VR headsets with video see-through (VST). In VST the physical world is displayed to the user through a camera system. In an AR/MR headset, virtual content is overlaid on the physical world. AR and MR are typically implemented as optical see-through (OST) technology, but can also be implemented with conventional camera and display, such as in a smartphone. Such displays are referred to herein as virtual displays, that is; displays used for displaying virtual content.

Virtual displays are commonly used to enable gaming in a virtual reality. Such virtual realities may be shared between several users. However, when a virtual reality is used to represent a physical reality some problems occur as will be discussed herein.

### SUMMARY

An object of the present teachings is to overcome or at least reduce or mitigate the problems discussed herein.

According to one aspect there is provided a virtual display arrangement comprising a display device, a communication interface and a controller, wherein the communication interface is configured to connect with a first remote-controlled vehicle, the controller is configured to receive user input and to control the first remote-controlled vehicle based on the user input along a track, and the display device is configured to show the first remote-controlled vehicle being navigated based on the user input along the track, wherein the communication interface is further configured to connect with a second virtual display arrangement controlling a second remote-controlled vehicle along a second track, and wherein the controller is configured to: receive information relating to navigation of the second remote-controlled vehicle along the second track, display a graphical representation of the second remote-controlled vehicle in the display device at a position relative the first remote-controlled vehicle on the track corresponding to a position of the second remote-controlled vehicle on the second track.

In some embodiments the track is determined based on a first recorded real-world track in an area where the first remote-controlled vehicle is navigated and wherein the controller is configured to manipulate the navigation of the first remote-controlled vehicle along the first recorded real-world track according to alignment information determined based on the first recorded real-world track and a second recorded real-world track in an area where the second remote-controlled vehicle is navigated.

In some embodiments the alignment information relates to adapting the navigation of the first remote-controlled vehicle so as to enable the first remote-controlled vehicle to navigate the first recorded real-world track as if navigating a same common track as the second remote-controlled vehicle, and is determined based on an alignment of the first and second recorded real-world tracks.

In some embodiments the alignment information is determined by identifying differentiating portions between the first real-world track and the second real-world track, the differentiating portions comprising differences, determine adaptations to enable the first and/or the second remote-controlled vehicles to be navigated through the differentiating portions and thereby cancelling out the differences.

In some embodiments the identifying the differentiating portions by determining that the second recorded real-world track is more irregular than the first real world track and in response thereto providing adaptations for the first remote-controlled vehicle for navigating the first recorded real world track based on the second recorded real world track.

In some embodiments the identifying the differentiating portions by determining that a first portion in the second recorded real-world track is more irregular than a corresponding second portion of the first real world track and in response thereto providing adaptations for the first remote-controlled vehicle for navigating the second portion based on the first portion.

In some embodiments the irregularity is determined based on length.

In some embodiments the irregularity is determined based on sum of curvatures.

In some embodiments the alignment information is further determined by a scaling operation.

In some embodiments the alignment information is further determined by a rotating operation.

In some embodiments the first recorded real-world track is selected out of one or more first recorded real-world tracks and the second recorded real-world track is selected out of one or more second recorded real-world tracks based on a similarity between the first and the second recorded real-world tracks (T1, T2).

In some embodiments the first recorded real-world track is selected based on identifying differentiating portions between the first recorded real world track (T1) and the second recorded real world track (T2); identifying objects in the differentiating portions; indicate the identified objects as objects to be moved; and record a new version of the first recorded real-world track.

In some embodiments the processing is performed by the controller of the virtual display arrangement and wherein the communication interface is configured to receive information representing the second recorded real world track.

In some embodiments the processing is performed by the second virtual display arrangement and wherein the communication interface is configured to transmit information representing the first recorded real world track to the second virtual display arrangement and to receive the alignment information from the second virtual display arrangement.

In some embodiments the, processing is performed by a server and wherein the communication interface is configured to transmit information representing the first recorded real world track to the server and to receive the alignment information from the server.

In some embodiments the display device is configured to show the first remote-controlled vehicle being navigated based on the user input along the track by receiving at least one image of the first remote-controlled vehicle being navigated based on the user input along the track and displaying said at least one image on the display device.

In some embodiments the virtual display arrangement is a smartphone or a tablet computer.

In some embodiments the virtual display arrangement is a head-mounted display device.

In some embodiments the virtual display arrangement is an optical see-through device.

In some embodiments the first remote controlled vehicle is a remote controlled car or a drone.

According to one aspect there is provided a system comprising a virtual display arrangement according to any previous claim and a server.

According to one aspect there is provided a method for use in a virtual display arrangement, wherein the method comprises: connecting with a first remote-controlled vehicle, receiving user input and controlling the first remote-controlled vehicle based on the user input along a track, showing the first remote-controlled vehicle being navigated based on the user input along the track, connecting with a second virtual display arrangement controlling a second remote-controlled vehicle along a second track, receiving information relating to navigation of the second remote-controlled vehicle along the second track, and displaying a graphical representation of the second remote-controlled vehicle at a position relative the first remote-controlled vehicle on the track corresponding to a position of the second remote-controlled vehicle on the second track.

According to one aspect there is provided a computer-readable medium carrying computer instructions that when loaded into and executed by a controller of a virtual display arrangement enables the virtual display arrangement to implement the method according to herein.

According to one aspect there is provided a software component arrangement for use in a virtual display arrangement comprising an optical device, wherein the software component arrangement comprises: a software component for connecting with a first remote-controlled vehicle, a software component for receiving user input and controlling the first remote-controlled vehicle based on the user input along a track, a software component for showing the first remote-controlled vehicle being navigated based on the user input along the track, a software component for connecting with a second virtual display arrangement controlling a second remote-controlled vehicle along a second track, a software component for receiving information relating to navigation of the second remote-controlled vehicle along the second track, and a software component for displaying a graphical representation of the second remote-controlled vehicle at a position relative the first remote-controlled vehicle on the track corresponding to a position of the second remote-controlled vehicle on the second track.

According to one aspect there is provided a virtual display arrangement comprising: a circuitry for connecting with a first remote-controlled vehicle, a circuitry for receiving user input and controlling the first remote-controlled vehicle based on the user input along a track, a circuitry for showing the first remote-controlled vehicle being navigated based on the user input along the track, a circuitry for connecting with a second virtual display arrangement controlling a second remote-controlled vehicle along a second track, a circuitry for receiving information relating to navigation of the second remote-controlled vehicle along the second track, and a circuitry for displaying a graphical representation of the second remote-controlled vehicle at a position relative the first remote-controlled vehicle on the track corresponding to a position of the second remote-controlled vehicle on the second track.

According to one aspect there is provided a virtual display arrangement comprising a display device, a communication interface and a controller, wherein the communication interface is configured to connect with a first remote-controlled vehicle, the controller is configured to receive user input and to control the first remote-controlled vehicle based on the user input along a first track, and the display device is configured to show the first remote-controlled vehicle being navigated based on the user input along the first track, wherein the communication interface is further configured to connect with a second virtual display arrangement controlling a second remote-controlled vehicle along the first track as a virtual vehicle (220VR) along a virtual track corresponding to the first track, and wherein the controller is configured to receive information relating to navigation of the second remote-controlled vehicle along the first track, and display a graphical representation of the second remote-controlled vehicle in the display device at a position relative the first remote-controlled vehicle on the first track corresponding to a position of the second remote-controlled vehicle on the first track, and wherein the controller is configured to determine that a virtual gateway (J1,L1) is reached and in response thereto cause the display device to display the first vehicle as a virtual representation in a virtual world and receive information relating to navigation of the first remote-controlled vehicle as a virtual vehicle along a virtual second track in the virtual world.

In some embodiments the virtual second track corresponds to a real-world second track in a second area of the second virtual display arrangement.

In some embodiments the second virtual display arrangement controls the second remote-controlled vehicle along the second track as a real-world vehicle along the second track.

In some embodiments the virtual display arrangement is further configured to return the remote-controlled vehicle along a return path.

In some embodiments the virtual display arrangement is further configured to determine that the time to navigate the return path exceeds the time needed to navigate the second track, and in response thereto insert a virtual path in a corresponding virtual gateway and receive information relating to navigation of the first remote-controlled vehicle as a virtual vehicle along the virtual path in the virtual world.

In some embodiments the virtual display arrangement is further configured to second virtual display arrangement controls the second remote-controlled vehicle along the virtual path as a virtual vehicle in the virtual world. In some embodiments the virtual display arrangement is further configured to determine that a time to initiate the first remote-controlled vehicle is required and in response thereto insert a further virtual path.

In some embodiments the virtual display arrangement is further configured to determine that the remote-controlled vehicle is not repositioned in time for the vehicle to remerge and in response thereto insert a further virtual path.

In some embodiments the virtual display arrangement is further configured to inserting a virtual path by causing a connected server to insert the virtual path.

According to one aspect there is provided a system comprising a virtual display arrangement according to any previous claim and a server.

According to one aspect there is provided a method for use in a virtual display arrangement, the method comprising: connecting with a first remote-controlled vehicle; receiving user input and to controlling the first remote-controlled vehicle based on the user input along a first track; showing the first remote-controlled vehicle being navigated based on the user input along the first track; connecting with a second virtual display arrangement controlling a second remote-controlled vehicle along the first track as a virtual vehicle along a virtual track corresponding to the first track; receiving information relating to navigation of the second remote-controlled vehicle along the first track; displaying a graphical representation of the second remote-controlled vehicle in the display device at a position relative the first remote-controlled vehicle on the first track corresponding to a position of the second remote-controlled vehicle on the first track; determining that a virtual gateway (J1,L1) is reached and in response thereto displaying the first vehicle as a virtual representation in a virtual world and receiving information relating to navigation of the first remote-controlled vehicle as a virtual vehicle along a virtual second track in the virtual world.

According to one aspect there is provided a computer-readable medium carrying computer instructions that when loaded into and executed by a controller of a virtual display arrangement enables the virtual display arrangement to implement the method according to herein.

According to one aspect there is provided a virtual display arrangement comprising: a software component for connecting with a first remote-controlled vehicle; a software component for receiving user input and to controlling the first remote-controlled vehicle based on the user input along a first track; a software component for showing the first remote-controlled vehicle being navigated based on the user input along the first track; a software component for connecting with a second virtual display arrangement controlling a second remote-controlled vehicle along the first track as a virtual vehicle (220VR) along a virtual track corresponding to the first track; a software component for receiving information relating to navigation of the second remote-controlled vehicle along the first track; a software component for displaying a graphical representation of the second remote-controlled vehicle in the display device at a position relative the first remote-controlled vehicle on the first track corresponding to a position of the second remote-controlled vehicle on the first track; a software component for determining that a virtual gateway (J1,L1) is reached and a software component for displaying the first vehicle as a virtual representation in a virtual world in response to determining that the virtual gateway is reached and a software component for receiving information relating to navigation of the first remote-controlled vehicle as a virtual vehicle along a virtual second track in the virtual world in response to determining that the virtual gateway is reached.

According to one aspect there is provided a virtual display arrangement comprising: a circuitry for connecting with a first remote-controlled vehicle; a circuitry for receiving user input and to controlling the first remote-controlled vehicle based on the user input along a first track; a circuitry for showing the first remote-controlled vehicle being navigated based on the user input along the first track; a circuitry for connecting with a second virtual display arrangement controlling a second remote-controlled vehicle along the first track as a virtual vehicle along a virtual track corresponding to the first track; a circuitry for receiving information relating to navigation of the second remote-controlled vehicle along the first track; a circuitry for displaying a graphical representation of the second remote-controlled vehicle in the display device at a position relative the first remote-controlled vehicle on the first track corresponding to a position of the second remote-controlled vehicle on the first track; a circuitry for determining that a virtual gateway (J1,L1) is reached and a circuitry for displaying the first vehicle as a virtual representation in a virtual world in response to determining that the virtual gateway is reached and a circuitry for receiving information relating to navigation of the first remote-controlled vehicle as a virtual vehicle along a virtual second track in the virtual world in response to determining that the virtual gateway (J1,L1) is reached.

In some embodiments the virtual display arrangement is a smartphone or a tablet computer.

In some embodiments the virtual display arrangement is a head-mounted display device.

In some embodiments the virtual display arrangement is an optical see-through device.

The solution may be implemented as a software solution, a hardware solution or a mix of software and hardware components.

Further embodiments and advantages of the present invention will be given in the detailed description. It should be noted that the teachings herein find use in object detection and virtual display arrangements in many areas of computer vision, including image retrieval, industrial use, robotic vision, augmented reality, simulations, gaming and video surveillance.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a virtual display arrangement according to some embodiments of the present invention;

FIG. 1B shows a schematic view of a virtual display arrangement according to some embodiments of the present invention;

FIG. 1C shows a schematic view of a virtual display arrangement according to some embodiments of the present invention;

FIG. 1D shows a schematic view of a virtual display arrangement according to some embodiments of the present invention;

FIG. 1E shows a schematic view of a virtual display arrangement according to some embodiments of the present invention;

FIG. 2 shows a schematic view of a virtual display system according to some embodiments of the teachings herein;

FIG. 3A shows a schematic view of a remote controlled vehicle according to some embodiments of the teachings herein;

FIG. 3B shows a schematic view of a remote controlled vehicle according to some embodiments of the teachings herein;

FIG. 4A shows a schematic view of a combined system according to some embodiments of the teachings herein;

FIG. 4B shows an example for the combined system according to some embodiments of the teachings herein;

FIG. 4C shows an example for the combined system according to some embodiments of the teachings herein;

FIG. 4D shows an example for the combined system according to some embodiments of the teachings herein;

FIG. 5A shows an example of how two tracks can be combined according to some embodiments of the teachings herein;

FIG. 5B shows an example of how two tracks can be combined according to some embodiments of the teachings herein;

FIG. 5C shows an example of how two tracks can be combined according to some embodiments of the teachings herein;

FIG. 5D shows an example of how two vehicles are enabled to navigate two combined tracks according to some embodiments of the teachings herein;

FIG. 6 shows a flowchart of a general method according to some embodiments of the teachings herein;

FIG. 7 shows a component view for a software component arrangement according to some embodiments of the teachings herein;

FIG. 8 shows a component view for an arrangement comprising circuits according to some embodiments of the teachings herein;

FIG. 9A shows an alternative or additional manner of combining two physical worlds or tracks according to some embodiments of the teachings herein;

FIG. 9B shows the perspective of a first user and the perspective of a second user according to some embodiments of the teachings herein;

FIG. 9C shows how return paths are followed according to some embodiments of the teachings herein;

FIG. 10 shows a flowchart of a general method according to some embodiments of the teachings herein;

FIG. 11 shows a component view for a software component arrangement according to some embodiments of the teachings herein;

FIG. 12 shows a component view for an arrangement comprising circuits according to some embodiments of the teachings herein;

FIG. 13 shows a schematic view of an example embodiment according to some embodiments of the teachings herein;

FIG. 14 shows a schematic view of an example embodiment according to some embodiments of the teachings herein;

FIG. 15 shows a schematic view of an example embodiment according to some embodiments of the teachings herein; and

FIG. 16 shows a schematic view of a computer-readable medium carrying computer instructions that when loaded into and executed by a controller of an arrangement enables the arrangement to implement some embodiments of the teachings herein.

### DEFINITIONS

Augmented reality (AR) augments the real world and its physical objects by overlaying virtual content. This virtual content is often produced digitally and incorporates sound, graphics, and video. For instance, a shopper wearing augmented reality glasses while shopping in a supermarket might see nutritional information for each object as they place it in their shopping cart. The glasses augment reality with pertinent information.

Virtual reality (VR) uses digital technology to create an entirely simulated environment. Unlike AR—which augments reality—VR is intended to immerse users inside an entirely simulated experience. In a full VR experience, all visuals and sounds are produced digitally and does not have any input from the user's actual physical environment. Specifically, Virtual reality allows a user to fully immerse into a world of a game for an increased gaming experience.

Mixed reality (MR) combines elements of both AR and VR. In the same vein as AR, MR environments overlay digital effects on top of the user's physical environment. However, MR integrates additional, richer information about the user's physical environment such as depth, dimensionality, and surface textures. In MR environments, the end user experience therefore more closely resembles the real world. To concretize this, consider two users hitting an MR tennis ball in a real-world tennis court. MR could incorporate information about the hardness of the surface (grass versus clay), the direction and force the racket struck the ball, and the players' height.

N.B. Augmented reality and mixed reality are often used to refer the same idea. Even though Mixed reality and Augmented reality are different in a sense that Mixed reality allows the user to interact in real-time with virtual objects that are placed within the real world. While augmented reality does not necessarily encompass that virtual/overlayed objects will respond and react to user as if they were real objects. However, for simplification, in this document, the word “augmented reality” also refers to the mixed reality.

Extended reality (XR) is an umbrella term referring to all real-and-virtual combined environments, such as AR, VR and MR. Therefore, XR provides a wide variety and vast number of levels in the reality-virtuality continuum of the perceived environment, bringing AR, VR, MR and other types of environments (e.g., augmented virtuality, mixed, reality, mediated reality, etc.) under one term. For simplification, in this document, the word “augmented reality” also refers to the extended reality.

An AR device will be referenced as the device which will be used as an interface for the user to perceive both virtual and/or real content in the context of augmented reality. Such device will typically have a display which could be opaque display both the environment (real or virtual) and virtual content together (i.e., video see-through), or overlay virtual content through a semi-transparent display (optical see-through). The AR device would need to acquire information about the environment using sensors (typically cameras and inertial sensors) to map the environment while simultaneously keeping track of the device's location within it.

Simultaneous Localization and Mapping (SLAM) is the computational problem of constructing or updating a (3D) map of a physical environment while simultaneously tracking the position of the agent (human, robot etc.) within that environment.

### DETAILED DESCRIPTION

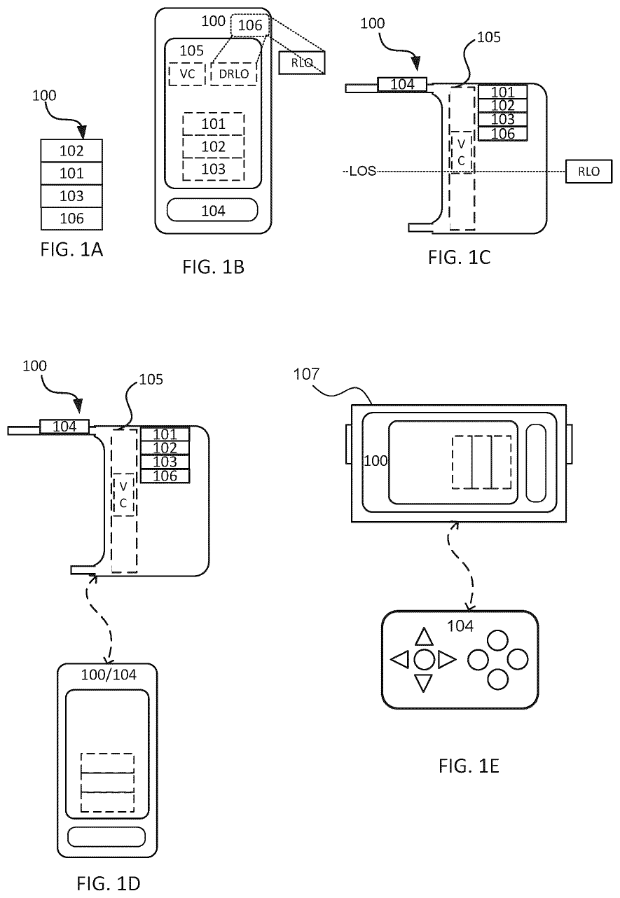

FIG. 1A shows a schematic view of a virtual display arrangement 100 according to some embodiments of the present invention. It should be noted that the virtual display arrangement 100 may comprise a single device or may be distributed across several devices and apparatuses. Some specific examples will be discussed in relation to FIGS. 1D and 1E. The virtual display arrangement 100 is in some embodiments an AR device.

The virtual display arrangement 100 comprises or is operably connected to a controller 101 and a memory 102. The controller 101 is configured to control the overall operation of the virtual display arrangement 100. In some embodiments, the controller 101 is a graphics controller. In some embodiments, the controller 101 is a general purpose controller. In some embodiments, the controller 101 is a combination of a graphics controller and a general purpose controller. As a skilled person would understand there are many alternatives for how to implement a controller, such as using Field-Programmable Gate Arrays circuits, ASIC, GPU, etc. in addition or as an alternative. For the purpose of this application, all such possibilities and alternatives will be referred to simply as the controller 101.

The memory 102 is configured to store graphics data and computer-readable instructions that when loaded into the controller 101 indicates how the virtual display arrangement 100 is to be controlled. The memory 102 may comprise several memory units or devices, but they will be perceived as being part of the same overall memory 102. There may be one memory unit for a display arrangement storing graphics data, one memory unit for optical device storing settings, one memory for the communications interface (see below) for storing settings, and so on. As a skilled person would understand there are many possibilities of how to select where data should be stored and a general memory 102 for the virtual display arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

In some embodiments the virtual display arrangement 100 also comprises an optical device, such as for example an image capturing device 106 (such as a camera or image sensor) capable of capturing an image or series of images (video) through receiving light (for example visual, ultraviolet or infrared to mention a few examples), possibly in cooperation with the controller 101. In some alternative embodiments the virtual display arrangement 100 also comprises an optical device capable of receiving data representing an image or series of images possibly in cooperation with the controller 101. The optical device 106, possibly in combination with the controller 101, is thus configured to receive an image or series of images captured by the optical device 106, and detect an object (indicated RLO (Real Life Object) in FIG. 1B) therein. The optical device 106 may be comprised in the virtual display arrangement 100 by being housed in a same housing as the virtual display arrangement, or by being operably connected to it, by a wired connection or wirelessly.

The virtual display arrangement 100 is also connected to or comprises a display arrangement 105 (not shown in FIG. 1A, but discussed in relation to FIG. 1B) for displaying received/captured images as well as virtual content.

FIG. 1B shows a schematic view of a virtual display arrangement 100 being a viewing device 100 according to some embodiments of the present invention. In such embodiments, the viewing device 100 is a smartphone or a tablet computer, being examples of Virtual See Through (VST) devices. In such some embodiments, the viewing device further comprises a (physical) display arrangement 105, which may be a touch display, and the optical device 106 may be one or more cameras of the smartphone or tablet computer. It should be noted that even though the virtual display arrangement 100 comprises a camera, it may still as an alternative or additional feature receive the image or series of images from a remote optical device, or an image storage. Such embodiments apply to all embodiments discussed in relation to FIGS. 1A to 1E.

In some embodiments the controller 101 is configured to receive an image from the camera 106 and possibly display the image on the display arrangement 105 along with virtual content VC. The virtual content is generated by the controller or received from the memory 102 or an external device through a communication interface 103 that will be discussed in further detail in the below. In the example embodiment of FIG. 1B, the camera(s) 106 is arranged on a backside (opposite side of the display 105, as is indicated by the dotted contour of the camera(s) 106) of the virtual display arrangement 100 for enabling real life objects (indicated RLO in FIG. 1B) behind the virtual display arrangement 100 to be captured and shown to a user (as a displayed RLO (DRLO) as indicted by the dotted lines from the RLO, through the camera to the DRLO on the display 105) on the display 105 along with any virtual content to be displayed. The displayed virtual content may be information and/or graphics indicating and/or giving information.

FIG. 1C shows a schematic view of a virtual display arrangement being an optical see-through (OST) viewing device 100 according to some embodiments of the present invention. The viewing device 100 is an optical see-through device, where a user looks in through one end, and sees the real-life objects (RLO) in the line of sight (LOS) at the other end of the viewing device 100.

In some embodiments the viewing device 100 is a head-mounted viewing device 100 to be worn by a user (not shown explicitly in FIG. 1C) for looking through the viewing device 100. In one such embodiment the viewing device 100 is arranged as glasses, or other eye wear including goggles, to be worn by a user.

The viewing device 100 is in some embodiments arranged to be hand-held, whereby a user can hold up the viewing device 100 to look through it.

The viewing device 100 is in some embodiments arranged to be mounted on for example a tripod, whereby a user can mount the viewing device 100 in a convenient arrangement for looking through it. In one such embodiment, the viewing device 100 may be mounted on a dashboard or in a side-window of a car or other vehicle.

The viewing device 100 comprises a display arrangement 105 for presenting virtual content VC to a viewer, whereby virtual content VC may be displayed to supplement the real-life view being viewed in line of sight.

FIG. 1D shows a schematic view of a virtual display arrangement being a combination of an optical see-through (OST) viewing device 100 and a smartphone being used as a user interface 104 for the viewing device 100 according to some embodiments of the present invention, the user interface 104 being for receiving control commands from a user. In some embodiments, the smartphone may also be arranged to perform at least some of the processing of the content to be displayed.

FIG. 1E shows a schematic view of a virtual display arrangement being a combination of a smartphone 100 and a user interface device 104 being arranged for receiving control commands from a user, such as a game console. In such an embodiment the smartphone 100 may be mounted or carried in a holder 107, for enabling the smartphone to be worn on a user's head, the smartphone 100 being used as a virtual see-through (VST) viewing device 100.

In the following, simultaneous reference will be made to the virtual display arrangements 100 of FIGS. 1A, 1B, 1C, 1D and 1E.

In some embodiments the virtual display arrangement 100 may further comprise a communication interface 103. The communication interface 103 may be wired and/or wireless. The communication interface 103 may comprise several interfaces.

In some embodiments the communication interface 103 comprises a USB (Universal Serial Bus) interface. In some embodiments the communication interface 103 comprises a HDMI (High Definition Multimedia Interface) interface. In some embodiments the communication interface 103 comprises a Display Port interface. In some embodiments the communication interface 103 comprises an Ethernet interface. In some embodiments the communication interface 103 comprises a MIPI (Mobile Industry Processor Interface) interface. In some embodiments the communication interface 103 comprises an analog interface, a CAN (Controller Area Network) bus interface, an I2C (Inter-Integrated Circuit) interface, or other interface.

In some embodiments the communication interface 103 comprises a radio frequency (RF) communications interface. In one such embodiment the communication interface 103 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communications interface 103 such as a fifth generation (5G) cellular communication interface 103, an LTE (Long Term Evolution) interface, a GSM (Global System for Mobile Communications) interface and/or other interface commonly used for cellular communication. In some embodiments the communications interface 103 is configured to communicate using the UPnP (Universal Plug n Play) protocol. In some embodiments the communications interface 103 is configured to communicate using the DLNA (Digital Living Network Appliance) protocol.

In some embodiments, the communications interface 103 is configured to enable communication through more than one of the example technologies given above. As an example, a wired interface, such as MIPI could be used for establishing an interface between the display arrangement, the controller and the user interface, and a wireless interface, for example WiFi™ could be used to enable communication between the virtual display arrangement 100 and an external host device (not shown).

The communications interface 103 may be configured to enable the virtual display arrangement 100 to communicate with other devices, such as other virtual display arrangements 100 and/or smartphones, Internet tablets, computer tablets or other computers, media devices, such as television sets, gaming consoles, video viewers or projectors (not shown), or image capturing devices for receiving the image data streams.

A user interface 104 is in some embodiments comprised in the virtual display arrangement 100 (only shown in FIGS. 1B and 1C). Additionally or alternatively, (at least a part of) the user interface 104 may be comprised remotely in the virtual display arrangement 100 in a separate device connected through the communication interface 103, the user interface then (at least a part of it) not being a physical means in the virtual display arrangement 100, but implemented by receiving user input through a remote device (shown in FIGS. 1D and 1E) through the communication interface 103. One example of such a remote device is a game controller, a mobile phone handset, a tablet computer or a computer.

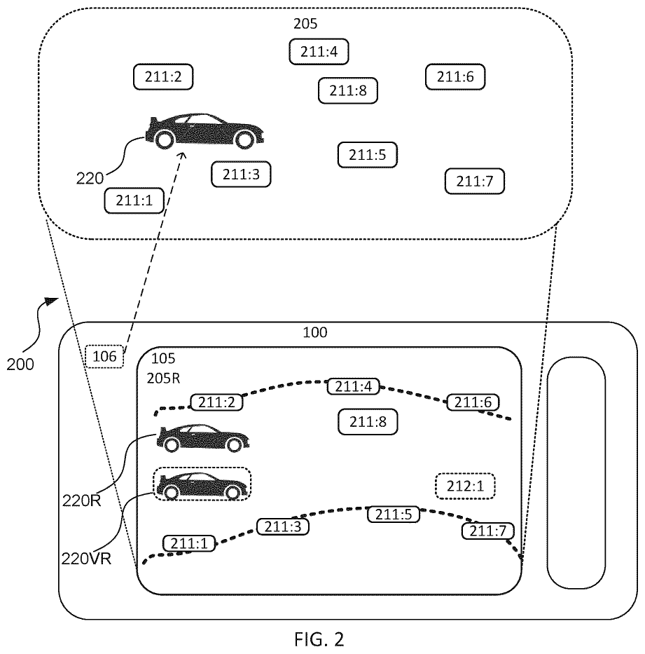

FIG. 2 shows a schematic view of virtual display system 200 according to the teachings herein. The virtual display system 200 comprises a virtual display arrangement 100 according to any of the embodiments disclosed above and herein. In the example view of FIG. 2, the virtual display arrangement 100 is aimed or directed at a general area 205 in which a remote-controlled (RC) vehicle 220 is arranged. The remote-controlled-vehicle may be comprised in the virtual display system 200. The general area 205 may be any area including rooms, hallways, houses, outdoor spaces, and/or other building structures in any (possibly partial) combination.

The general area 205 will hereafter be referred to simply as an area 205. The area 205 is an area where the RC vehicle 220 is supposed to be navigated around in. The area 205 may further comprise any number of objects 211. The objects 211 may be any kind of object including objects part of or present in the area 205, such as furniture or other objects commonly found in houses. In some embodiments there are objects placed in the area to serve a specific purpose. Such a specific purpose may be to mark a course to be navigated, an obstacle to be negotiated (avoided or requiring other specific maneuver) or an object to be interacted with. In the example of FIG. 2, there are eight (8) objects 211:1-8, whereof seven (7) objects 211:1-7 are used to mark a course and object 211:8 being an obstacle to be negotiated. Examples of objects used to mark a course are cones, painted lines, lines, or other objects commonly used to mark a course. Some objects may be arranged with a specific marking that can be identified by the controller, which marking indicated the type of obstacle/object that is represented by the object, for example an obstacle or an object that when interacted provides a specific function.

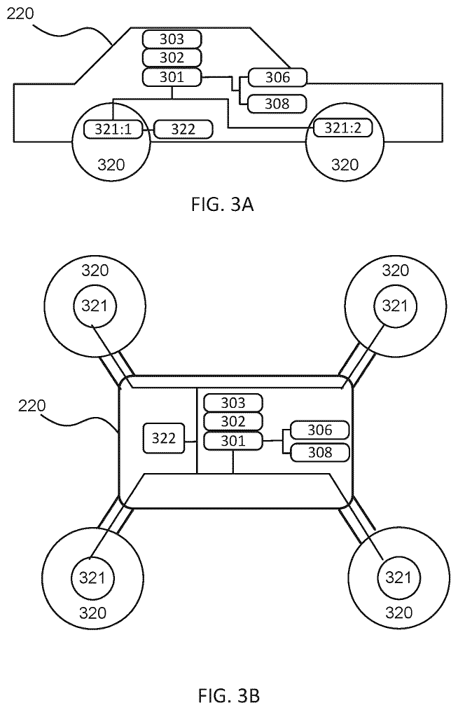

The area 205 is captured through an image or rather a series of images so as that the area 205 can be displayed on a display arrangement 105 as a representation 205R of the area 205. The image or images is in some embodiments captured by the camera 106 of the virtual display arrangement 100 and/or by a camera (referenced 306 in FIGS. 3A and 3B) of the RC vehicle.

The virtual display arrangement 100 is thus configured to receive images of the area 205 and of the RC vehicle 220 and to display a representation 220R of the RC vehicle in a representation 205R of the area on the display arrangement 105. The virtual display arrangement 100 is further configured to display virtual objects representing zero, one, some or all of the physical objects 211:1-8. In the example of FIG. 2, the objects 211-:1-7 being used to mark a course, are displayed as being part of a marked course as indicated by the dotted lines.

In embodiments where the virtual display arrangement 100 is an OST device, the images of the area is simply the images or view viewable through the OST device 100. In some such embodiments where the virtual display arrangement 100 is an OST device, the representation of the RC vehicle 220R is simply the view of the RC vehicle 220 as seen through the OST device 100.

The virtual display arrangement 100 is also configured to receive data regarding a virtual vehicle 220VR and virtual objects 212:1 that are also displayed in the display arrangement 105.

FIG. 3A shows a schematic view of a remote-controlled vehicle 220, in this figure exemplified as a land-based vehicle, specifically a car. FIG. 3B shows a schematic view of a remote-controlled vehicle 220, in this figure exemplified as a drone. The RC vehicle 220 comprises one or more propulsion devices 320, which in FIG. 3A are exemplified as at least two wheels for the land-based vehicle 320 in FIG. 3A, and by one or more rotors 320, specifically in this example 4 rotors 320, in FIG. 3B. The propulsion devices 320 are drivably connected to or comprises each at least one navigation device, which in FIG. 3A are exemplified as an electric motor 321:1 and a steering mechanism 321:2, and in FIG. 3B exemplified as one electric motor 321 per rotor 320. The propulsion devices 320(/321) are operatively connected to a power source 322, such as a battery arranged to feed the electric motor(s) 321 with electric current.

The RC vehicle further comprises a controller 301, a memory 302 and a communication interface 303. The controller 301 is configured to control the overall operation of the RC vehicle 220. The memory 302 is configured to store settings and instructions to enable the controller 301 to operate the RC vehicle. The communication interface is arranged to connect to the virtual display arrangement 100 (or a user interface device such as a remote control, referenced 104 in FIG. 1E) to supply images and other sensor input, or location constructs generated based on such images and other sensor input, and to receive control information or commands for remotely controlling the RC vehicle 220.

To enable providing image(s) and other sensor input, and/or to enable generating location-constructs, the RC vehicle further comprises a visual sensor, such as a camera 306, and motion sensors 308, such as accelerometers, odometers or gyroscopes to mention a few examples. The use of both visual sensors and motion sensors enables for navigating and also for generating a map of the mobility area 205 (at least the areas traversed) utilizing (Visual) Simultaneous Location and Mapping techniques ((V)SLAM).

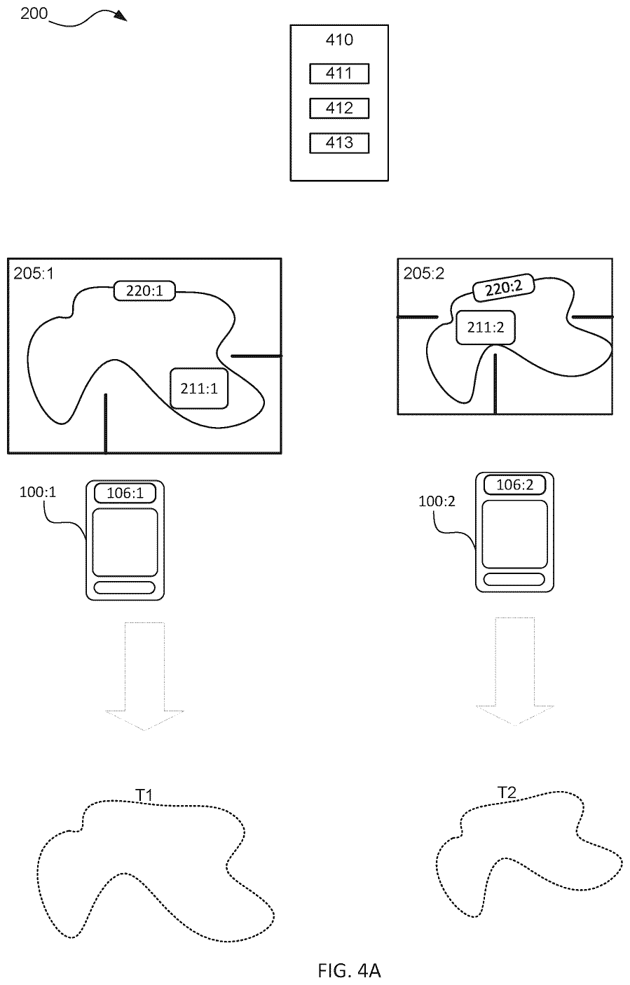

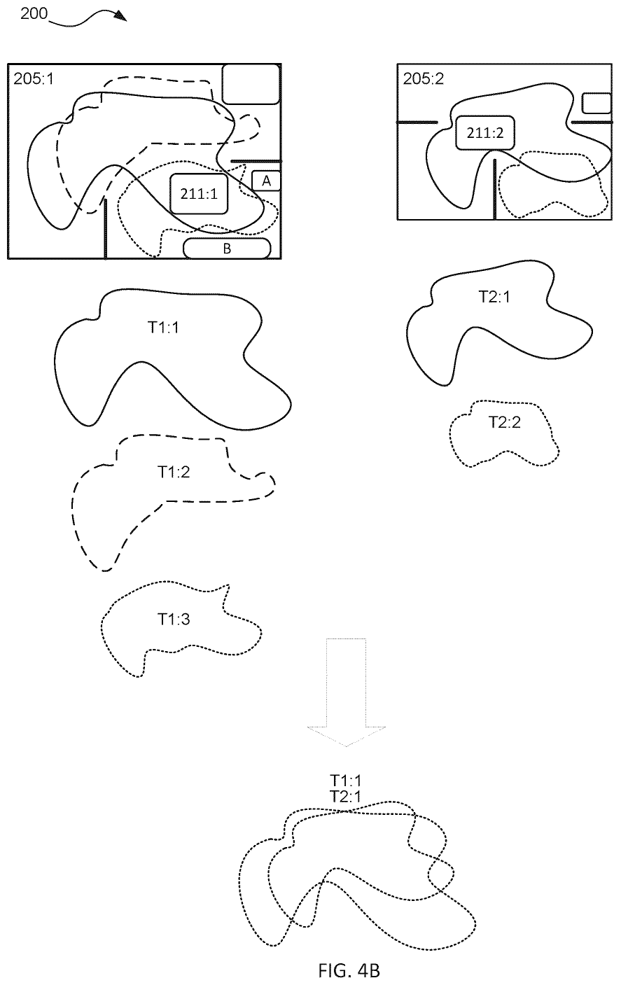

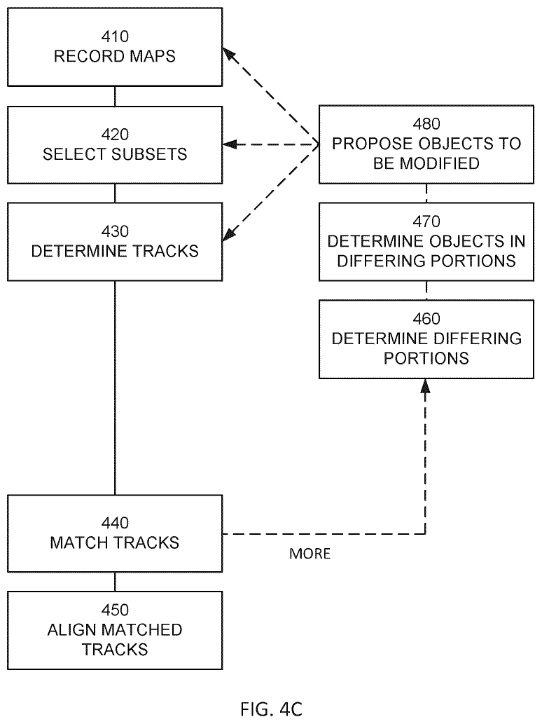

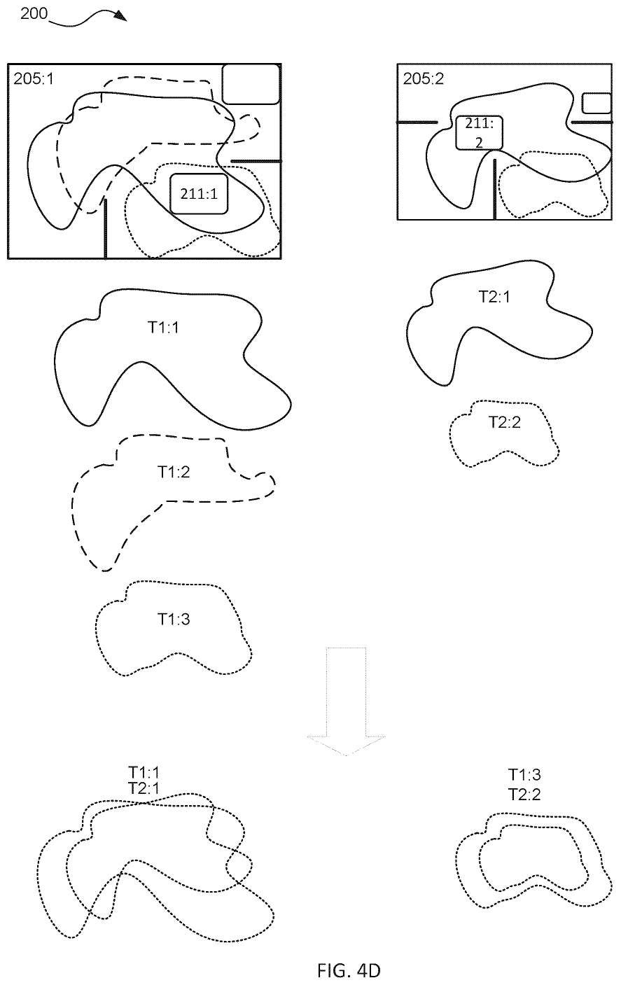

FIG. 4A shows a schematic view of a combined system 200 where a first virtual display arrangement 100:1 monitors a first area 205:1 in which a first RC vehicle 220:1 is arranged to be controlled by the first virtual display arrangement 100:1 (possibly in combination with a remote control as discussed in relation to FIG. 1E for example), and a second virtual display arrangement 100:2 monitors a second area 205:2 in which a second RC vehicle 220:2 is arranged to be controlled by the second virtual display arrangement 100:2. Each virtual display arrangement 100 and RC vehicle combination is configured to navigate a course (indicated by the line) in the respective area 205, and determine or extract the course as a computerized course or track T1, T2 respectively utilizing for example (V) SLAM techniques. The processing may be done in part or completely by the RC vehicle 220, the virtual display arrangement 100 or possibly through a connected server 410. Such a server comprises a controller 411, for controlling the operation of the server 410, a memory 412 for storing data and/or instructions enabling the controller 411 to determine all or any of the tracks T1, T2, and a communication interface 413 for receiving data from any of the virtual display arrangements 100 and/or the RC vehicles 220, as well as providing data on the generated track(s) and any virtual objects to be placed in the tracks.

As is indicated in FIG. 4A, the two areas 205 may be of different size and/or layout. The two areas 205 may also comprise different objects 211:1 and 211:2 respectively.

As discussed in the above, each virtual display arrangement 100 in combination with the respective RC vehicle 220 are capable of determining a track T1, T2 respectively through processing data from the camera 306 and the sensor inputs from the sensor(s) 308 of the RC vehicle 220 possibly in combination with data from the camera 106 of the virtual display arrangement 100. The camera 106 of the virtual display arrangement 100 may be used to give an overview image of the area 205 to facilitate determining how objects are located relative to one another.

This enables a user to place an RC vehicle 220 in an area 205 and then control the RC vehicle as navigating through a virtual or rather augmented or mixed world where virtual objects are also located and to be navigated, negotiated or interacted with.

In some embodiments, it is a user that carries a virtual display arrangement 100 or other device, and thereby records the track.

As will be discussed in the below, the track may be recorded in a number of manners, and exactly how is not essential. It can also be noted, and as will be discussed in the below, that there may be more than one track recorded in an area, of which a (best) match is determined for the received track(s) of which there may also be more than one, in order to find the tracks best suited to align to one another.

FIG. 4B shows an example where there are three tracks recorded in the first area 205:1 and two tracks recorded in a second area 205:2. FIG. 4C shows a general flowchart for a method for how tracks in different physical locations may be recorded, modified and matched to one another. The method is discussed based on the example of FIG. 4B.

A map (or more than one) of each area 205 or of the track in the area 205 is recorded 410 by each user. The map may be generated of the area by a user walking in the area, by the vehicle navigating through the area or based on overview images of the area.

A subset of the area 205 may be selected 420 for further use. Based on the recorded map, one or more tracks in each area is determined 430. In case the map(s) is generated by following a track, this is a mere selection of a track. In case the map is of the area, possible tracks may be generated based on free surfaces in the area, or rather selected subset(s) of the area. This enables for a user to determine a track, by simply selecting area(s) that the track should run through. Extracting or determining a possible path through an environment is known and will thus not be discussed in further details herein.

As at least one track in each area has been determined, the tracks are matched 440. The matching is based on finding tracks that have similarities, wherein the similarities are in their respective shapes, and wherein the number of similar shapes exceed a matching threshold. The matching may be done in a server 410 or in one of the virtual display arrangements 100. In the example of FIG. 4B, three tracks are recorded or determined in the first area 205:1, namely T1:1, T1:2 and T1:3, and two tracks are recorded or determined in the second area 205:2, namely T2:1 and T2:2.

As a matching pair of tracks have been found, they are aligned 450 possibly in a manner as discussed in the below, to accommodate for any differences in their shapes.

If no matching pairs are found—or if simply more tracks are wanted, possibly by being commanded by a user or being a requirement—the maps are analyzed to determine 460 differing portions of tracks. The analysis may be done in a server 410 or in one of the virtual display arrangements 100. In the example of FIG. 4B, the two tracks T1:3 and T2:2 show some similarities but have two differing portions; the bottom part and the upper right corner.

Real-life objects are then detected 470 and possibly identified or classified in the differing portions. The detection may be done in a server 410 or in one of the virtual display arrangements 100. In the example of FIG. 4B, there are two objects A, B in the first area 205:1 that are blocking any expansion of the track T1:3 to be more similar to the track T2:2.

These objects are then provided or indicated 480 to a user for suggested moving so as to enable for a better match of track(s) running through the vicinity of the object.

As the objects have been moved—as indicated possibly by user input indicating this or by a new recording of the area and/or tracks—tracks are determined again 430 for matching 440 and alignment 450. As indicated in FIG. 4C, new subsets may be selected and/or new recording of maps may also be performed before recording new (versions of) tracks. In some embodiments, only the portion of the track or area that has been changed is re-recorded, thereby avoiding the work of mapping or recording the whole area or track again. A new version of the track is thereby recorded regardless of manner of doing so.

FIG. 4D shows the example of FIG. 4B where two objects A, B are detected, proposed to be moved, and subsequently moved whereby new tracks are identified, whereby a match between T1:3 and T2:2 is also possible.

While the user is mapping the environment and adapting the environment to the second user's environment, it might be so that as the area is bigger or more flexible multiple options of a track can be achieved. The user in this case can choose from using one of the tracks manually, let the system choose one or use multiple tracks. The tracks can change through-out the gameplay and the laps can be alternated between the different mapped tracks in the environment.

It can also be the case, where real objects will change depending on the lap. As such moved objects or new objects appear, this is recorded and forwarded, whereby the tracks are affected with moved or new virtual objects. In other words, the second user will experience new or moved virtual obstacles in his real-world experience depending on what track that is chosen.

The real mapped track will not change necessarily for the second user except for short snippets. The tracks may thus be aligned dynamically and possibly not only statically before start of any simulation.

The principles of the approach described above can also be applied to more than two users (i.e. more than two physical environments).

However, the inventors have realized that even though there exists VR systems where different users located in different physical locations are able to operate in a same virtual environment, those users are not able to manipulate or navigate physical vehicles or other objects in their respective locations in a manner where the virtual worlds are aligned and where the vehicles interact with the same objects and on the same terms, irrespective of any differences between the physical locations, both as relates to layout and content.

The inventors have therefore devised a clever and insightful solution, where the tracks determined for each location or area 205 are aligned with one another to provide a combined track that can be navigated on equal terms by each user at their respective location while coexisting in a virtual world and interacting in that virtual world. As is shown in FIG. 4A, the two locations differ which results in different tracks even if the same track was supposed to be recorded by each virtual display arrangement-vehicle combination.

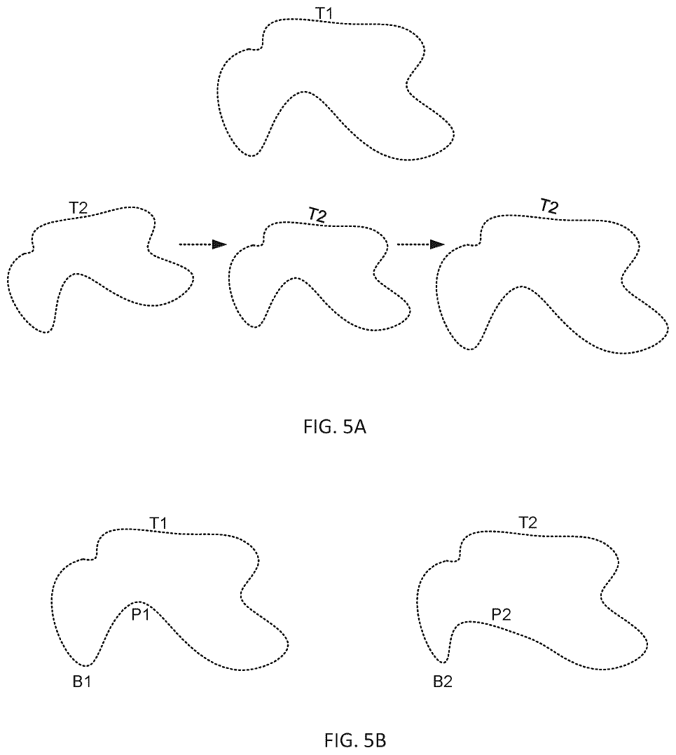

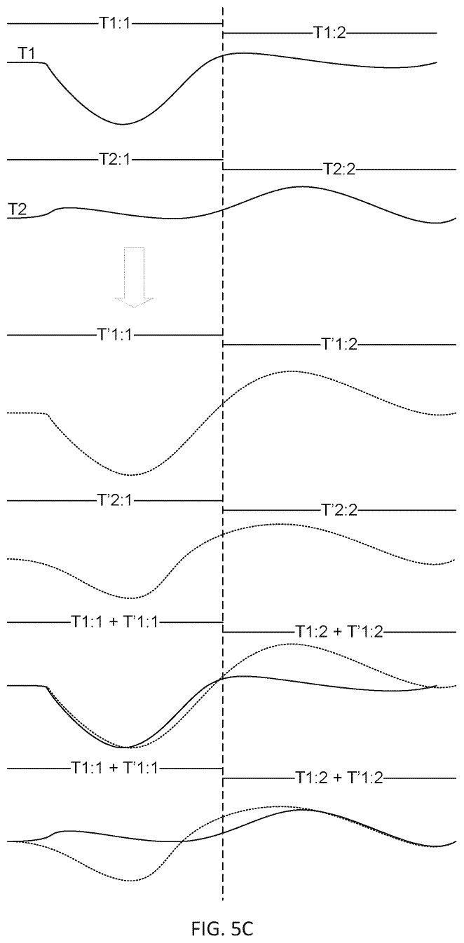

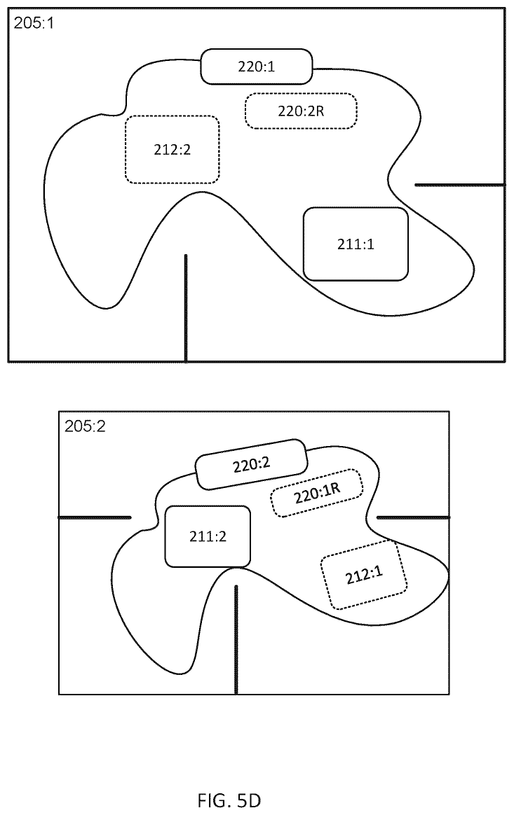

FIG. 5A shows a schematic view of how two tracks (or more) can be aligned with one another. FIG. 5A shows how the first track T1 of the first virtual display arrangement 100 of FIG. 4A can be aligned with the second track, from the perspective of the first virtual display arrangement 100. As discussed in relation to FIG. 4, the virtual display arrangement 100 (or the server) determines a track T1, from now on referred to as a recorded track as it is based on sensor and image recordings made by the RC vehicle. The virtual display arrangement 100 (or the server) also receives a second track T2, hereafter referred to as a received track T2. As is illustrated in FIG. 5A, the recorded track T1 does not equal the received track T2, and the received track T2 is therefore to be aligned with the recorded track T1 so that the two tracks can be navigated on equal terms. This allows for two vehicles at different (physical) locations to navigate the same general track on equal terms, possibly to perform joint simulations, to perform joint virtual tasks, or to race one another each vehicle racing its own physical track, but at the same time appearing in the augmented reality of the other vehicle to enable a shared augmented reality experience.

In FIG. 5A it is shown how the received track is aligned in several steps, which in the example of FIG. 5A includes a rotation followed by a scaling, whereby the two tracks are aligned. This allows for aligning tracks that are of different size and not rotated the same way, i.e. it allows for aligning tracks of a same general shape to find a best match. This allows for compensating for differences in sizes of different locations, for example rooms and so on as previously discussed.

However, the inventors have further realized that the tracks at the different locations may not be of the same general shape as it may be difficult (as exact measurements may be difficult to make) or impossible (due to structural limitations) for two different users to set up the same (exact or similar) shape of the track. The inventors have also realized that even small differences in tracks may result in major differences in handling capabilities through the track of the vehicle. The inventors are therefore also proposing to align a track to another track so that both tracks may be navigated on equal terms, by adapting at least a virtual shape of the track.

There are two possible options, to adapt the recorded track according to the received track, or to adapt the received track according to the recorded track. As will be discussed later these two options may also be combined into a combined option.

FIG. 5B shows a situation where a first (for the sake of this example a recorded) track T1 is slightly different from a second (for the sake of this example a received) track T2. In this example this difference is seen in the bottom part of the tracks T1, T2, where the second track has a narrower hairpin turn followed by a wider sweeping turn. Such slight differences will result in completely different handling characteristics of two vehicles each navigating a corresponding track whereby the two tracks will not be navigated on equal terms.

As such (at least) one track will be adapted according to the other one. As discussed above, such adaptation is also applied to the aligning by scaling and/or rotating of a track.

The adaptation is achieved by manipulating or adapting the steering of the vehicle. In some embodiments the adaptation is to manipulate the steering input given through the user interface 104. In some embodiments the adaptation is to manipulate the steering output given through the communication interface 103 of the virtual display arrangement 100 to the vehicle 220. In some embodiments the adaptation is to manipulate the steering input received by the vehicle through the communication interface 303 of the vehicle 220. In some embodiments the adaptation is a combination of some or all of such embodiments. To manipulate the steering input received by the vehicle through the communication interface 303. The manipulation is in some embodiments performed by the controller 101 of the virtual display arrangement 100. The manipulation is in some embodiments performed by the controller 301 of the vehicle 220. The manipulation is in some embodiments performed by the controller 411 of the server 410. The manipulation is in some embodiments a combination of some or all of such embodiments. The adaptation through manipulation enables for a same steering input given through a respective user interface 104 to result in a same progress of the corresponding tracks.

In some embodiments the manipulation relates to manipulating or adapting a (real) speed of the vehicle to slow down (or speed up) the vehicle to accommodate for difference in tracks. In the example of FIG. 5B, the adaptation may be to slow down the vehicle navigating track T1 through the bend (or turn) B1 to simulate a lower possible speed through the corresponding tighter bend B2.

Similarly, the second track T2 may be adapted according to the first track T1, by slowing down the speed of the second vehicle through the following portion P2 in the second track, which (in this example) is longer than the corresponding portion P1 in the first track T1, so that the two portions will take the same time to navigate for the same steering input given through a respective user interface 104.

A scaling of one track will also result in a manipulation of the speed of one or both of the vehicles to accommodate for the scaling.

In some embodiments the manipulation relates to manipulating or adapting a propensity for slipping or losing traction—i.e. the ability to keep a turning degree at a given speed—of the vehicle to accommodate for differences in tracks. In the example of FIG. 5B, the adaptation may be to make the vehicle (or simulate that the vehicle) spin out when going through the bend B1 at a higher speed than is determined to be possible to simulate a lower possible speed through the corresponding tighter bend B2. This may be used to simulate different road conditions such as wet roads or other track conditions. A simulation of such spin out could be to simply stop or slow down the vehicle, while showing the augmented or virtual representation of the vehicle to spin out or other simulated behavior.

As a skilled person would understand, such manner of simulating a real event is applicable to all events.

In some embodiments the manipulation relates to manipulating or adapting a (real) speed of the vehicle to slow down (or speed up) the vehicle to accommodate for difference in elevations of tracks. In the example of FIG. 5B, the adaptation may be to slow down the vehicle navigating track T1 to simulate an increase in elevation at the corresponding track T2.

In general, the teachings herein thus provide how two (or more) tracks can be aligned to one another.

Firstly, tracks are recorded and matching tracks with identical or similar geometry are determined, while utilizing/maximizing the space being used. How this may be done is exemplified in the above with reference to FIG. 4C.

Secondly, the tracks are aligned to one another. This is done by adapting or morphing segments or portions of the tracks differentiated scaling. Some principles are discussed below in addition to or as alternatives to the one discussed other where in this text.

If one vehicle shall take a longer path, its speed will be adapted accordingly so that the time taken would be the same. If this is on a straight path, this does not significantly change difficulty level.

If the path is differentiated by curves or curvatures, i.e. the trajectory differs, it may not be sufficient to change the speed/curvature of the vehicle since also the difficulty-level will be affected. For example, a physically sharp curve more easily leads to that a car skids. The risk of skidding is non-linear relative to speed, so it may not be sufficient to adapt the speed linearly with the distance-it must take forces into consideration to maintain difficulty-level.

In some cases, it is not possible to adapt speed/curvature so that the difference in distance is fully compensated without significantly changing the difficulty-level. Then, a delta-index is added for the track with the higher difficulty level.

If there is a large delta-index between two users, indicating that one user is expected to have a lower difficulty-level, this is taken into consideration, in some embodiments, in other parts of the track.

Since the tracks are calculated ahead of the execution of the navigation of the tracks, the candidate tracks can be defined taking also easily movable objects into consideration (meaning that the users get suggestions of thing to be moved in order to make larger and more even tracks). Medium movable objects can either be taken into consideration to start with, or only in case it is not possible to find tracks of reasonable size and with reasonably similar difficulty level.

In case of a large delta-index for the two tracks, indicating that the tracks that will be raced have significantly different difficulty level, the overall game might compensate for that in different ways, for example by adding virtual obstacles or other problems for the user with the less difficult track.

As mentioned above, either track may be aligned to either other track. In some embodiments the more regular track (which assumingly would be easier to navigate) is adapted according to the more irregular track as such adaptation most likely would result in a lowering of speeds, which is always possible.

As also mentioned above and discussed in relation to FIG. 5B, a combination of which track is aligned to which may be performed. FIG. 5C shows schematic view of two portions T1:1, T1:2 and T2:1, T2:2 of corresponding tracks T1, T2 where the first track T1 is more irregular in the first portion T1:1, T2:1 and the second track T2 is more irregular in the second portion T1:2, T2:2.

In such an example, a controller (central, local, remote or a combination) will then determine that the first portion T2:1 of the second track T2, being the more regular portion, is to be aligned to the first portion T1:1 of the first track T1. And that that the second portion T1:2 of the first track T1, being the more regular portion, is to be aligned to the second portion T2:2 of the second track T2.

The resulting aligned tracks T1′, T2′ and their respective portions are shown in FIG. 5C under the doted arrows (representing processing). FIG. 5C also shows how the aligned tracks T1′, T2′ and their respective portions will look like in comparison to the original tracks T1, T2.

In some embodiments the determination which (portion of a) track is the more irregular is performed based on a comparison of the length of the (portion of the) tracks. The longer length indicating the more irregular (portion of) track.

In some embodiments the determination which (portion of a) track is the more irregular is performed based on a comparison of the total curvatures or sum of angular changes of the (portion of the) tracks. The sum of angular changes indicating the more irregular (portion of) track.

In some embodiments the determination which (portion of a) track is the more irregular is performed based on a combination of a comparison of the total curvatures or sum of angular changes of the (portion of the) tracks and a comparison of the length of the (portion of the) tracks.

In some embodiments the combination is made so that the difference (delta) between the physical and the combined virtual worlds is within a threshold limit, in some embodiments less than 40%.

In some embodiments the combination is made so that the difference (delta) between the physical and the combined virtual worlds is the same for both (all) players. In some embodiments the types of changes get different weights.

In such a calculation less capable players are prioritized so that the virtual track corresponds (more accurately) to the real-world track of that player In some embodiments the adaptation is performed locally to one track where an adaptation is performed if it is determined that the received track is more irregular (in a portion) than the recorded track (in a corresponding portion). In such embodiments the adaptation is performed by the controller 101 of the virtual display arrangement 100 and/or the controller 301 of the vehicle 220. The user thus adapts the track to be navigated.

In some embodiments the adaptation is performed remotely to one track where an adaptation is performed if it is determined that the recorded track is more irregular (in a portion) than the received track (in a corresponding portion). In such embodiments the adaptation is performed by the controller 101 of the virtual display arrangement 100 and/or the controller 301 of the vehicle 220 prior to sending the recorded track to the other user. The adaptation then being performed remotely to the receiver of the adapted track. The user thus receiving an already adapted track.

In some embodiments the adaptation is performed centrally to one or both tracks where an adaptation is performed for the track that is more regular (in a portion). In such embodiments the adaptation is performed by the controller 411 of the server 410 after receiving both recorded tracks T1 and T2, and then providing tracks to be navigated to both users, i.e. both users receives adapted tracks to be navigated.

FIG. 5D shows a schematic view of how a first vehicle 220:1 and a second vehicle 220:2 are enabled to navigate a corresponding track T1, T2 on equal terms experiencing the same objects 211:1, 211:2. In this view it is shown how the user of the first vehicle 220:1 will be provided with a virtual or augmented representation 220:2R of the second vehicle 220:2 and a virtual or augmented representation 212:2 of the object(s) 211:2 in the track area 205:2. It is also shown how the user of the second vehicle 220:2 will be provided with a virtual or augmented representation 220:1R of the first vehicle 220:1 and a virtual or augmented representation 212:1 of the object(s) 211:1 in the track area 205:1. These representations are provided in a virtual or augmented reality version of the respective track area 205 enabling each user to experience that the vehicles are navigating the same track on equal terms, facing the same obstacles.

In some embodiments the representation is given in an augmented reality, i.e. where the virtual objects are overlaid a real life view of the track area 205. The view may be given as a POV (point of view) view based on a camera in the vehicle 220. The view may be given as an overview or bird's eye view based on a camera in or connected to the virtual display arrangement 100.

In some instances, there may be more than one track in an area, and there may therefore be a plurality of recorded tracks. Consequently, there may also be more than one received track, as those are merely recorded tracks in the other area.

There may thus be one or more recorded tracks and one or more received tracks. In such an instance, the best matching recorded and received tracks are determined and used for aligning. There may be more than one best match, especially if a best match is determined based on exceeding a threshold. In such instances, the teachings herein apply to each matching pair.

As discussed in the above, a track is determined based on a mapping done by for example the vehicle 220 traversing the map. However, a track can be determined or recorded in alternative manners, such as through the use of a different device.

For the context of the teachings herein it is not essential how a track is recorded, only that it is recorded.

The inventors have realized that if there is a no match, or only bad or partial matches, such partial matches are most likely due to an object blocking a path of the track. By identifying the portions where the tracks differ, and detecting any object(s) in that portion, such object(s) can be indicated to a user for proposed removal so as to allow a better match of recorded and received paths.

The teachings herein solve problems of enabling a correspondence between a single physical and (multiple) virtual environments (i.e. one physical environment mapped/adapted to several virtual environments). The situation where multiple users from multiple physical environments wanting to cooperate in a shared virtual environment built from merging/adapting their own physical environments (such as from their homes) is a problem that the inventors have realized and provided a solution to through the teachings herein.

As the inventors have realized, the problem of merging/adapting multiple physical environments to a shared virtual environment cannot be trivially performed from the extension of prior works (i.e. based on single physical environment) because different physical environments have different constraints (such as size, footprint, object placements, etc.), and when constraints of the physical environments are too different to merge in the virtual environment, then other sophisticated approaches are needed which the inventors are providing through the teachings herein such as distance morphing and (non-linear) scaling and adaptation.

In addition to the other uses, that have been discussed herein, the teachings herein may be utilized in Simulation-based professional training, sports or gaming Virtual/mixed meetings and office presence over larger space Venn rooms for virtual social interaction in merged physical worlds Virtual meetings and office presence over larger space, as well as Venn rooms for virtual social interaction in merged physical worlds.

In some embodiments, objects with a specific marking (as discussed I the above) may be used to mark the track.

In some embodiments, objects with a specific marking (as discussed I the above) may be used to indicate an object that when interacted with activates a function that is executed such as leading to an action or changing a status, for example to change a characteristic (for example speed) of the vehicle interacting with it.

In some embodiments, a simulation of an event may be indicated and performed in the augmented world by affecting the vehicle in the real world, such as simulating repairs or refueling by pausing the vehicle. In some embodiments, a collision in the real world may be avoided by stopping the real world vehicle, while showing the virtual vehicle as colliding with the virtual object representing the real-world object.

In some embodiments, the virtual representation of a vehicle may be that of a vehicle of another type. This allows a simulation of a specific vehicle using another vehicle. For example, a user may navigate a car in the real world but appear to be navigating a drone in the virtual world. This also allows two users having access to different vehicles to navigate the same track on the same premises, where the virtual representations of the other vehicle is of the same sort as the real vehicle.

In such embodiments, the alignment of the track also includes adapting for the type of vehicle. For aligning a flying track and vehicle to a land-based track and vehicle any movements in a vertical height may be treated as an uphill or downhill section of the track, where the speed and also possibly the handling of the vehicle is adapted to simulate a car driving on the uphill/downhill section, when in real life a drone is flying upwards or downwards. Similarly, an adaption from a car to a drone is also possible and within the scope of the teachings herein.

As discussed in the above, two tracks are to be aligned to one another (in combination or one to the other) to provide a same or common track (being an alignment of each user's recorded track to the other user's recorded track), and such alignment may be done in each of the virtual display arrangements 100, each of the vehicles, in a server 410 or in any combination of some or all of these entities. Depending on where the processing is to be performed, reception of an aligned track or reception of a track to be aligned may include processing of actually aligning the track as well depending on the relevant embodiment.

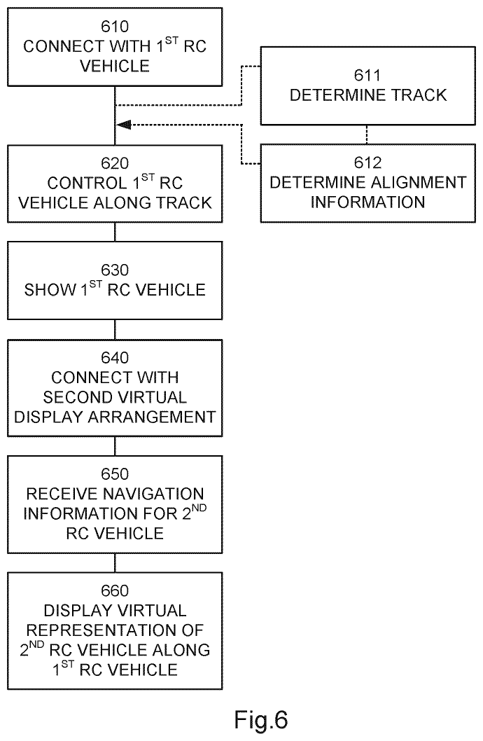

FIG. 6 shows a flowchart of a general method according to some embodiments of the teachings herein. The method utilizes a virtual display arrangement 100 as taught herein. Details on how the method is to be performed has been given above with reference to FIGS. 1A, 1B, 1C, 1D, 1E, 1F, 2A, 2B, 3A, 3B, 4A, 4B, 4C, 4D, 5A, 5B, 5C and 5D, and will be supplemented below with simultaneous reference to FIGS. 1A, 1B, 1C, 1D, 1E, 1F, 2A, 2B, 3A, 3B, 4A, 4B, 4C, 4D, 5A, 5B, 5C and 5D.

Through the method of FIG. 6, based on the teachings herein the virtual display arrangement 100 is configured for connecting 610 with a first remote-controlled vehicle (220), receiving user input and controlling 620 the first remote-controlled vehicle based on the user input along a track, and showing 630 the first remote-controlled vehicle being navigated based on the user input along the track. The first remote-controlled vehicle may be shown through the display device, the virtual display arrangement 100 being a see-through device. Alternatively, the first remote-controlled vehicle may be shown by receiving images of the first remote-controlled vehicle and displaying these images on the display device. The images may be received from a camera of the virtual display arrangement 100. Alternatively the images may be received from a camera in the vehicle. In such embodiments, the first remote-controlled vehicle is shown in a point-of-view configuration where a front or possibly nothing of the vehicle is shown in the view of the vehicle, the view from the vehicle then replacing the view of the vehicle. The virtual display arrangement 100 is further configured through the method for connecting 640 with a second virtual display arrangement (100:2) controlling a second remote-controlled vehicle along a second track, receiving information 650 relating to navigation of the second remote-controlled vehicle along the second track, and displaying 660 a virtual representation of the second remote-controlled vehicle at a position relative the first remote-controlled vehicle on the track corresponding to a position of the second remote-controlled vehicle on the second track. It should be noted that the virtual representation of a vehicle may be shown as a different type of vehicle.

In some embodiments the track is determined 611 based on a first recorded real-world track in an area 205:1 where the first remote-controlled vehicle is navigated and wherein the virtual display arrangement is further for manipulating the navigation of the first remote-controlled vehicle along the first recorded real-world track according to alignment information determined 612 based on the first recorded real-world track and a second recorded real-world track in an area (205:2) where the second remote-controlled vehicle is navigated. In some embodiments the determination of a track comprises selecting and/or modifying a track as discussed in relation to FIG. 4C. In some embodiments the determination of alignment information comprises aligning a track as discussed in relation to FIGS. 5A-5D, wherein the recorded track is the first recorded real-world track and the received track corresponds to the second recorded real-world track and the common track corresponds to the track to be navigated for the first vehicle.

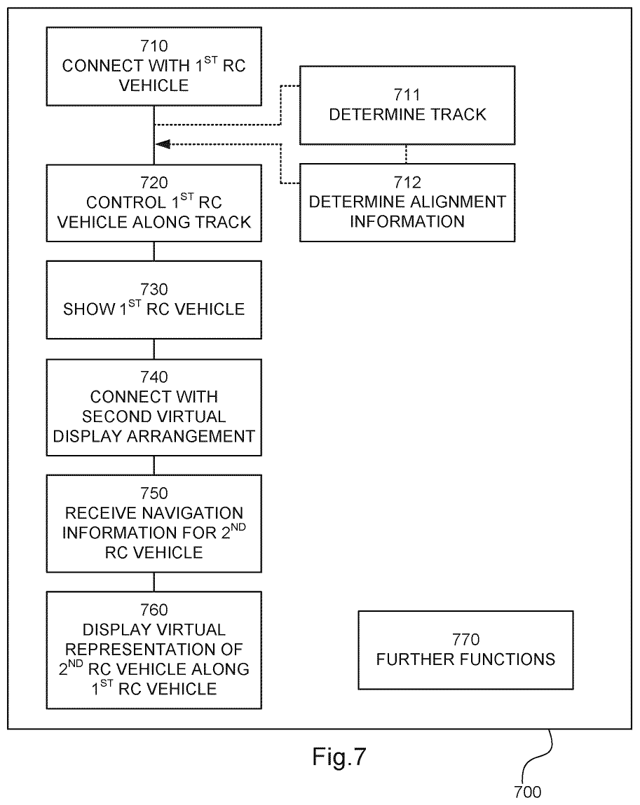

FIG. 7 shows a component view for a software component (or module) arrangement 700 according to some embodiments of the teachings herein. The software component arrangement 700 is adapted to be used in a virtual display arrangement 100 as taught herein.
The software component arrangement 700 comprises a software component 710 a software component for connecting with a first remote-controlled vehicle (220), a software component 720 for receiving user input and controlling the first remote-controlled vehicle based on the user input along a track, a software component 730 for showing the first remote-controlled vehicle being navigated based on the user input along the track, a software component 740 for connecting with a second virtual display arrangement (100) controlling a second remote-controlled vehicle (220) along a second track, a software component 750 for receiving information relating to navigation of the second remote-controlled vehicle along the second track, and a software component 760 for displaying a graphical representation of the second remote-controlled vehicle at a position relative the first remote-controlled vehicle on the track corresponding to a position of the second remote-controlled vehicle on the second track.

The software component arrangement 700 also comprises a software component 770 for implementing or executing further functionality as discussed herein

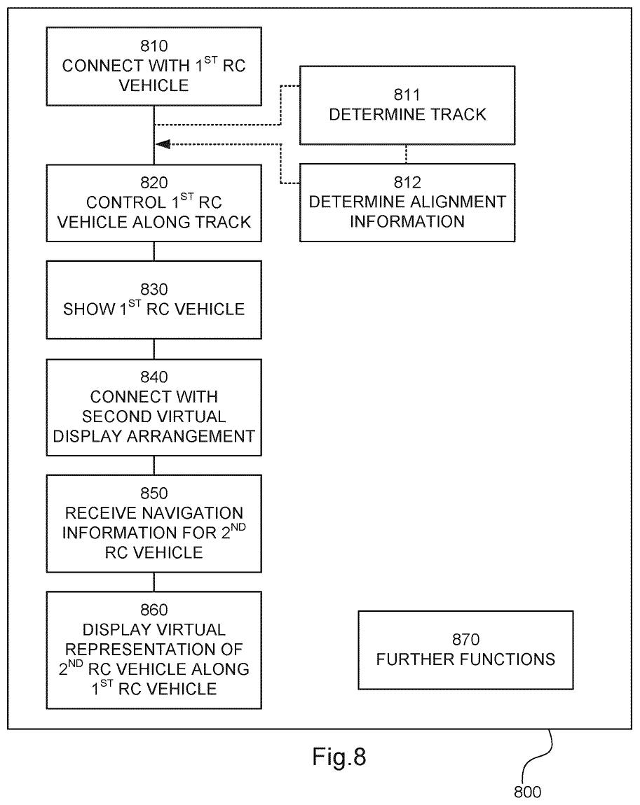

FIG. 8 shows a component view for an arrangement comprising circuitry for providing a virtual display 800 according to some embodiments of the teachings herein. The arrangement comprising circuitry for providing a virtual display detection 800 is adapted to be used in a virtual display arrangement 100 as taught herein.

The arrangement comprising circuitry for object detection 800 of FIG. 8 comprises a circuitry 810 for connecting with a first remote-controlled vehicle 220, a circuitry 820 for receiving user input and controlling the first remote-controlled vehicle based on the user input along a track, a circuitry 830 for showing the first remote-controlled vehicle being navigated based on the user input along the track, a circuitry 840 for connecting with a second virtual display arrangement 100:2 controlling a second remote-controlled vehicle 220 along a second track, a circuitry 850 for receiving information relating to navigation of the second remote-controlled vehicle along the second track, and a circuitry 860 for displaying a graphical representation of the second remote-controlled vehicle at a position relative the first remote-controlled vehicle on the track corresponding to a position of the second remote-controlled vehicle on the second track.

The arrangement comprising circuitry for object detection 800 also comprises a circuitry 870 for implementing or executing other functionality as discussed herein

This solves the problem of merging and adapting multiple physical environments into a shared environment, and in doing so, considering the constraints from physical environments as well as user preferences/constraints. A simplified scenario involving two users is as follows:

Two persons acting in their respective homes, home A and home B. Each having a physical racing car, e.g., a Nintendo Mario Kart Live: Home Circuit Mario racing car.

Their environments are pre-mapped. Then, to navigate their vehicles (cars) together, the system finds a combined track that involves both physical worlds. Hence, one real-world part of the track will be in home A and one real-world part of the track will be in home B, which are combined together to form one track which consist of both real-world parts and virtual parts for both users, where the user in home A races the real-world track A and experiences user B as if the user B is racing a virtual version of real-world track in home A and vice-versa.

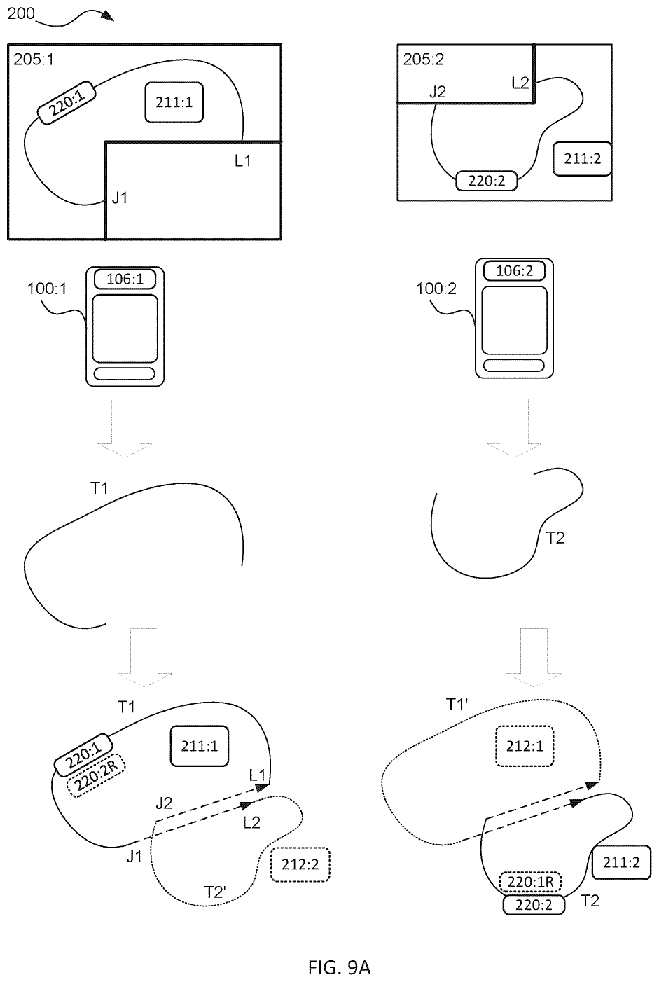

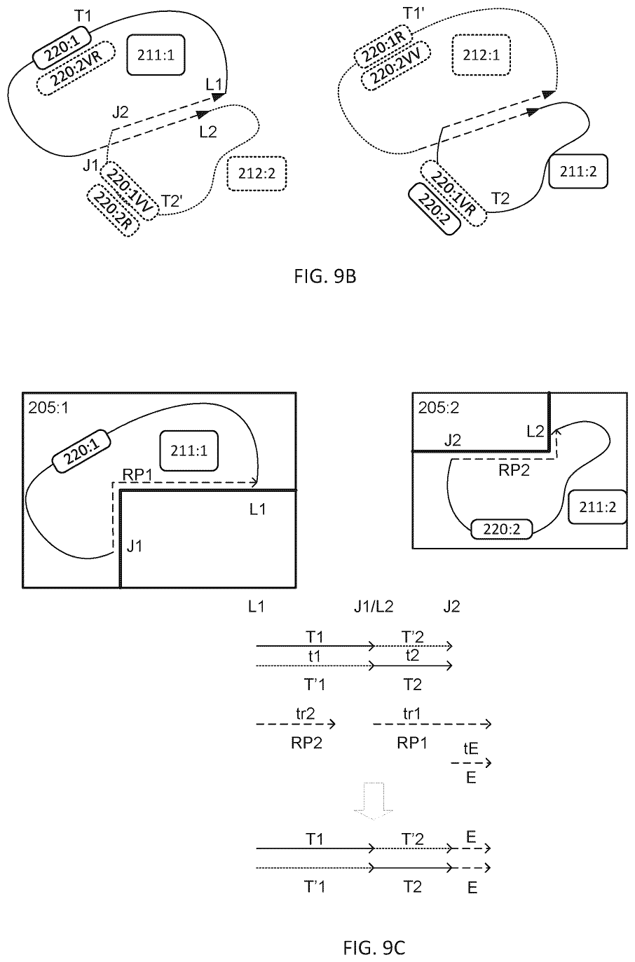

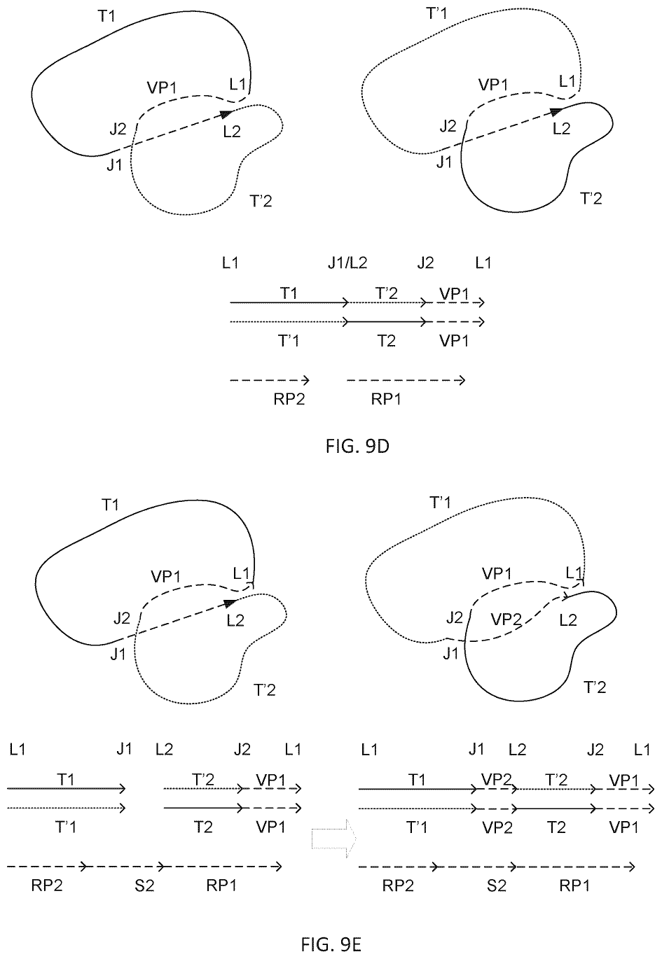

FIG. 9A shows an alternative or additional manner of combining two physical worlds or tracks. In this manner, which is easily combined with the manners discussed above in relation to the previous figures, a first user using a first virtual display arrangement 100:1 records or otherwise determines a track T1 in a first area 205:1. The track may be determined or otherwise selected in any of the matters as discussed in relation to FIGS. 4A, 4B, 3C and 4D. However, for the purpose of this manner, no comparison is needed with the tracks or other aspect of a second physical world. In some embodiments, the teachings that will be discussed in the below, may be used for the tracks identified in one area 205, but not finding any matches in the other area.

As is also shown in FIG. 9A, a second user using a second virtual display arrangement 100:2 records or otherwise determines a track T2 in a second area 205:2. The tracks T1 and T2 are not similar in shape.

The inventors have realized that to allow users in different physical locations where it is not possible to define tracks of a similar shape, or where it is not beneficial to do so in that much of the available space may be left unused, thus wasted, the physical tracks may be shared by being navigated one at a time. This allows for a simple construction of tracks, and for use of all or most of the available space.

FIG. 9A shows one example of how two tracks T1, T2 may be connected through the use of virtual gateways, exemplified in FIG. 9A as two jump points J1, J2 and two landing points L1, L2. In this manner two tracks may be shared by enabling one user to navigate the local track as a physical track with the vehicle in real-life, and to navigate the other remote track as a virtual track.

The virtual gateways are in some embodiments defined by a user.

From the perspective of the first user, the first track T1 has thus been recorded and information regarding the second track T2 is received from the second virtual display arrangement 100:2 (directly or indirectly via the server 410). The information regarding the second track T2 is utilized to define a virtual track. The first (real) track T1 is subsequently connected to the second (virtual) track through virtual gateways. In the examples of FIG. 9A and onwards, virtual representations and objects are shown with dotted lines, virtual gateways are shown in with dashed lines and real-world objects are shown with full lines.

Any physical object 211 detected with a physical track may also be part of the track and information regarding such objects is also part of the information regarding the track, thereby enabling for physical objects appearing as virtual objects 212 for the other user.

The first virtual display arrangement 100:1 is further configured to receive information regarding navigation of a second remote-controlled vehicle, and to display a virtual representation of the second remote controlled vehicle. This may be achieved in a manner as discussed in the above with reference to FIG. 5A.

As the first remote controlled vehicle 220:1 navigates the first track T1 it is shown as a real vehicle in an augmented (or mixed) reality view. Also shown is a virtual representation of the second remote controlled vehicle 220:2. This allows for the first and the second user to navigate the first track on equal terms, the first user in real world, and the second user in a virtual world.

As the first remote controlled vehicle reaches a virtual gateway, or more specifically as it reaches a jump point, the view presented on the display device 105 changes to a virtual display and a virtual world is presented to the first user. As the remote-controlled vehicle subsequently exits the virtual gateway, by effectively being transported to the corresponding landing point L1, the first user effectively enters a virtual world corresponding to the second area 205:2, where the second track is to be navigated as a virtual track by controlling a virtual vehicle, possibly being a virtual version of the first remote controlled vehicle 220:1.

FIG. 9B shows the perspective of the first user on the left, and the perspective of the second user on the right. Here it is clearly shown that the first user navigates the first track T1 as a real-world track using the first remote controlled vehicle 220:1 and that the first user navigates the second track T2 as a virtual track T2′ using virtual vehicle 220:1VV replacing the first remote controlled vehicle 220:1 in the virtual world of the virtual track T2′. The virtual vehicle 220:1VV can be a virtual representation of the first remote vehicle 220:1. However, as the first user navigates the second track in a virtual world, the virtual vehicle may be any type of vehicle.

As is also shown, the first remote controlled vehicle 220:1 is accompanied by a representation 220:2VR of the virtual vehicle 220:2VV of the second user, and the second remote controlled vehicle 220:2 is accompanied by a representation 220:1VR of the virtual vehicle 220:1VV of the first user. The virtual representation 220:1VO, 220:2VR of a virtual vehicle 2201:1VV, 220:2VV may be a same type of vehicle or it may be a different type of vehicle.

This allows a user to navigate different vehicles in the different tracks, and also possibly to appear as navigating a different type of vehicle, perhaps to better fit in in a virtual or real world of the other user. As an example, if the first user is navigating a remote-controlled car in the real-world, and a virtual helicopter in the virtual world, and the second user is navigating a remote-controlled boat in the real world and a motorcycle in the virtual world, the teachings herein allow for a joint experience where the user navigates different vehicles in different worlds, and possibly perceives different vehicles than the other user perceive. For the example of FIG. 9B on track T1 a car 220:1 races another 220:2R and on track T2′ a helicopter 220:1VV races another helicopter 220:2R as perceived by the first user, and on track T2 a boat 220:2 races another boat 220:1VR and on track T1′ a motorcycle 220:2VV races another motorcycle 220:1VR as perceived by the second user. It is also shown how the objects of the first area 211:1 appears as virtual objects 212:2 to the second user, and how the objects of the second area 211:2 appears as virtual objects 212:1 to the second user.

As the virtual representation is navigated to a second virtual gateway (or more specifically a second jump point J2) in the virtual world representing track T2 and generally the second area 205:2, the displayed world switches back to an augmented view where the real world first remote-controlled vehicle 220:1 is shown accompanied by a virtual representation representing the second remote controlled vehicle 220:2.

As the inventors have realized, the physical remote-controlled vehicle must reposition itself to allow for the simulation or shared experience to continue. The virtual display arrangement 100, either by direct control or through indirect control, is thus configured to reposition the remote-controlled vehicle 220 to a virtual gateway, more specifically to a next landing point L2, when reaching a virtual gateway, more specifically a previous jump point J1. This allows for the remote-controlled vehicle to be used again, if or rather when the virtual representation of the first remote controlled is navigated to reach a next virtual gateway (or rather next jump point) in the virtual world representing the second area from the perspective of the first user, and similarly from the perspective of the second user.

FIG. 9C shows how return paths are followed by the respective remote-controlled vehicle to reposition the remote-controlled vehicle for continued share experience(s). In FIG. 9C, the first remote-controlled vehicle 220:1 follows a first return path RP1, and the second remote-controlled vehicle 220:2 follows a second return path RP2.

In some embodiments a return path is recorded while the remote-controlled vehicle is navigated along the return path.

In some embodiments a return path is recorded by being detected as being a possible route in the recorded first area utilizing any method or manner for automatic route detection.

In some embodiments a return path is recorded by being indicated or otherwise input by a user, for example by specifying the return path on a map representation of the recorded track and/or the area 205.

As the inventors have realized, there is a problem that may arise in situations where there are differences in length between the first track T1 and T2, or rather where a virtual track is shorter (as regards the time it takes to navigate the track) than the corresponding return path. The return path corresponding to a track is the return path that a real-world remote-control vehicle is to return along, while a virtual representation of the vehicle is navigated in a virtual track.

In FIG. 9C the timing diagram of the example of FIG. 9C is shown, where the time length of the tracks and return paths are shown with arrows. In the example of FIG. 9C, the time t1 to navigate the first track T1 is longer than the time tr2 to navigate the corresponding second return path RP2. The second remote controlled vehicle will therefore (or at least should) be able to reposition itself before the second remote vehicle is again needed, i.e. when the second vehicle again enters the real-world of the second track T2.

However, the time t2 to navigate the second track T2 is shorter than the time tr1 to navigate the corresponding first return path RP1. The first remote-controlled vehicle will therefore not be able to reposition itself before the first remote vehicle is again needed, i.e. when the first vehicle again enters the real-world of the first track T1. A further time tE needed is indicated as an error time, where there is a mismatch or error in the location of the vehicle. The total time needed is indicated at the bottom of FIG. 9C. To enable for a shared experience, both users need to adhere to the same timing constraints and the times are thus applicable to both users.

The inventors have realized that a convenient manner of enabling the experience to be shared without interruptions and seamlessly is to extend the shared experience. This is done by simply and ingeniously extending the virtual tracks, by inserting a virtual path VP in the virtual gateways, more specifically between a virtual jump point and the corresponding landing point. As both users will experience the virtual gateway as a transition between real and physical world, neither will experience that the gateway is not instantaneous but extended. For example, even before the first user enters jump point 1 the first user perceives the second vehicle as a virtual vehicle, and as the jump point is entered all switches to virtual and there is thus no change in the perception of the second vehicle. Furthermore, as the first user exits the landing point L1, no change is made in how the first user perceives either of the second vehicle or the surrounding world. The first user will not be aware that for the second user, the perception changes from virtual to augmented. The first user will only be aware of a virtual world from the jump point. Similarly, the second user will only be aware of a virtual world up until the landing point, never aware of when the switch occurs for the first user. The gateways may thus be extended seamlessly without any of the users being able to tell the difference between the virtual world representing the other user's area, or a non-existent virtual path. By designing the virtual path to be longer than the return path, or rather longer than the difference between the length of the return path and the corresponding track, a seamless experience is thus provided. The length is here a time-length representing the time it takes to navigate the corresponding path or track.

In some embodiments, the length of the virtual path is determined based on a measurement of the return path. The measurement may be in a map or in real-life by navigating the vehicle along the return path. The measurement may be a determination based on the length of the return path and a speed of the vehicle.

In some embodiments, the length of the virtual path is set to be longer than the difference in length of the return path and the corresponding track. In some such embodiments, the length of the virtual path is set to be the length of the return path. Such embodiments provide for overhead to accommodate for unexpected situations where a vehicle may be needed sooner than calculated or assumed.

The inventors have also realized a further problem that may arise when a vehicle has a startup or initiation time, for example a drone that need to start-up the rotors. Another example is where the vehicle needs to be recharged.

In such situations the vehicle may not be ready to start even if the return path is sufficiently short. Actually, especially not if the return path is shorter than the corresponding track as that will increase the likelihood that the vehicle is set in a standby mode.

To overcome this, the vehicle may be initiated prematurely when it is determined that the virtual representation passes a point on the track, where the remaining navigation is assumingly of a (time) length corresponding to the time length of the initiation. However, the inventors have realized that this may lead to wasted energy consumption as a situation may occur which prolongs the reemergence of the vehicle. One example is the real-world vehicle crashing into an unexpected object which should halt the shared experience.

The inventors have therefore devised a simpler strategy, wherein a (second or further) virtual path VP2 is inserted to allow for the startup time (indicated S2 in FIG. 9E). The second or further virtual path may, in some embodiments, be inserted by extending the first virtual path. This enables for the initiation to be done while both vehicles are in the virtual world, where fewer unexpected situations may occur.

The length of the virtual path may in such cases be selected to correspond to the initiation time of the vehicle.

In some embodiments the length of the virtual path is thus determined based on an initiation time.

In some embodiments the length of the virtual path is determined to be the sum of the initiation time and the time for the return path.

In some embodiments, the virtual display arrangement 100 is configured to determine that the remote-controlled vehicle is not repositioned in time for the vehicle to remerge. For example as the virtual representation passes a marking position in the virtual world indicating an assumed time to completion. Or, for example that the remote-controlled vehicle is not positioned as the jump point is reached or an end of a virtual path.

As it is determined that the remote-controlled vehicle is not repositioned in time, the virtual display arrangement 100 may insert a further virtual path. In such embodiments, the virtual display arrangement communicates such a further virtual pathway to the second virtual display arrangement 100 for common executing or addition of the further virtual pathway. The communication may be direct or indirect via the server. In embodiments where the communication is indirect via the server, the virtual display arrangement may insert the further virtual path by communicating to the server that the remote-controlled vehicle will not be positioned in time, whereby the server inserts the further virtual path and communicates the inserted virtual path to both the first and the second virtual display arrangements 100.

Such manners of the server inserting the virtual and how a virtual path is communicated to the second virtual display arrangement 100 applies to all embodiments where a virtual path is to be inserted.

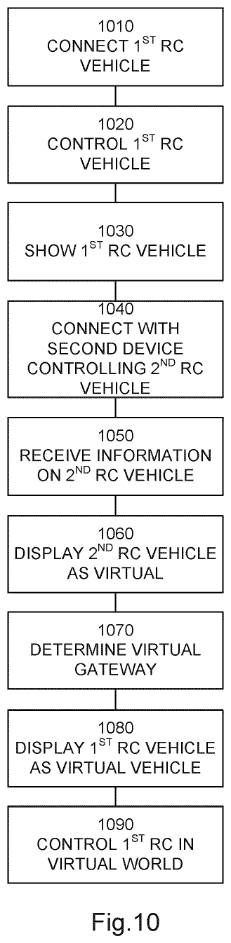

FIG. 10 shows a flowchart for a general method of the teachings herein. The virtual display arrangement 100 connects 1010 with a first remote-controlled vehicle 220, receives user input and controls 1020 the first remote-controlled vehicle based on the user input along a first track and shows 1030 the first remote-controlled vehicle being navigated based on the user input along the first track.

The virtual display arrangement 100 also connects 1040 with a second virtual display arrangement 100 controlling a second remote-controlled vehicle 220 along the first track as a virtual vehicle 220VR along a virtual track corresponding to the first track and receives 1050 information relating to navigation of the second remote-controlled vehicle along the first track and displays 1060 a graphical representation of the second remote-controlled vehicle in the display device 105 at a position relative the first remote-controlled vehicle on the first track corresponding to a position of the second remote-controlled vehicle on the first track. The virtual display arrangement determines 1070 that a virtual gateway J1,L1 is reached and in response thereto displays 1080 the first vehicle 220:1 as a virtual representation in a virtual world and receiving information relating to navigation of the first remote-controlled vehicle as a virtual vehicle along a virtual second track in the virtual world, i.e. the virtual display arrangement navigates or controls 1090 the first vehicle as a virtual vehicle in the virtual world.

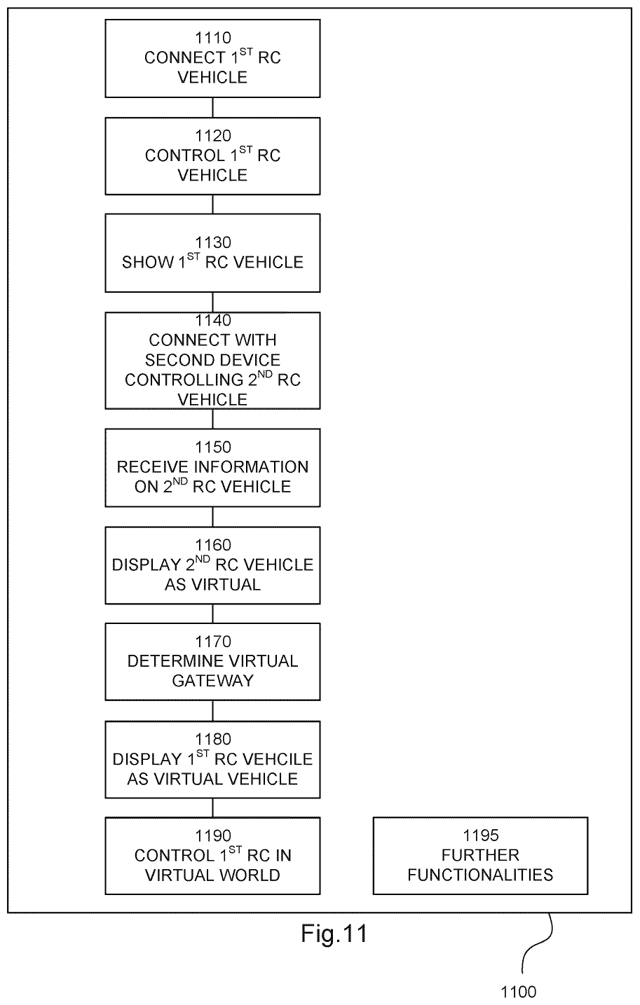

FIG. 11 shows a component view for a software component or module arrangement 1100 according to some embodiments of the teachings herein. The software component arrangement 1100 is adapted to be used in a virtual display arrangement 100 as taught herein.

The software component arrangement 1100 comprises a software component 1110 for connecting with a first remote-controlled vehicle 220; a software component 1120 for receiving user input and to controlling the first remote-controlled vehicle based on the user input along a first track; a software component 1130 for showing the first remote-controlled vehicle being navigated based on the user input along the first track; a software component for 1140 connecting with a second virtual display arrangement 100 controlling a second remote-controlled vehicle 220 along the first track as a virtual vehicle 220VR along a virtual track corresponding to the first track; a software component 1150 for receiving information relating to navigation of the second remote-controlled vehicle along the first track; a software component 1160 for displaying a graphical representation of the second remote-controlled vehicle in the display device 105 at a position relative the first remote-controlled vehicle on the first track corresponding to a position of the second remote-controlled vehicle on the first track; a software component 1170 for determining that a virtual gateway J1,L1 is reached and a software component 1180 for displaying the first vehicle 220:1 as a virtual representation in a virtual world in response to determining that the virtual gateway is reached and a software component 1190 for receiving information relating to navigation of the first remote-controlled vehicle as a virtual vehicle along a virtual second track in the virtual world in response to determining that the virtual gateway is reached.

The software component arrangement 1100 also comprises a software component 1195 for implementing or executing further functionality as discussed herein

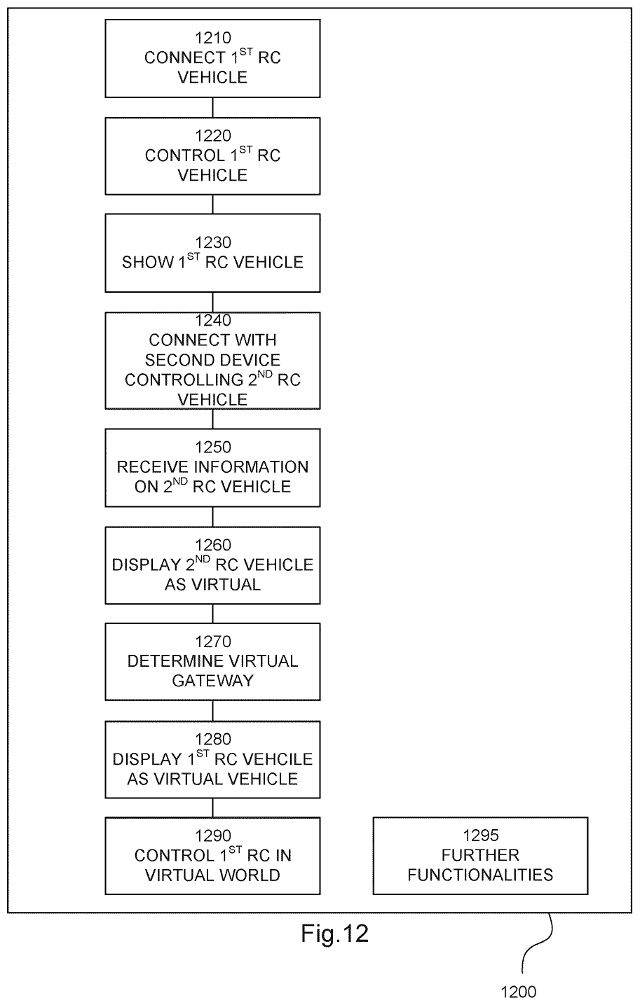

FIG. 12 shows a component view for an arrangement comprising circuitry for providing a virtual display 1200 according to some embodiments of the teachings herein. The arrangement comprising circuitry for providing a virtual display detection 1200 is adapted to be used in a virtual display arrangement 100 as taught herein.

The arrangement comprising circuitry for object detection 1200 of FIG. 12 comprises a circuitry 1210 for connecting with a first remote-controlled vehicle 220; a circuitry 1220 for receiving user input and to controlling the first remote-controlled vehicle based on the user input along a first track; a circuitry 1230 for showing the first remote-controlled vehicle being navigated based on the user input along the first track; a circuitry 1240 for connecting with a second virtual display arrangement 100 controlling a second remote-controlled vehicle 220 along the first track as a virtual vehicle 220VR along a virtual track corresponding to the first track; a circuitry 1250 for receiving information relating to navigation of the second remote-controlled vehicle along the first track; a circuitry 1260 for displaying a graphical representation of the second remote-controlled vehicle in the display device 105 at a position relative the first remote-controlled vehicle on the first track corresponding to a position of the second remote-controlled vehicle on the first track; a circuitry 1270 for determining that a virtual gateway J1,L1 is reached and a circuitry 1280 for displaying the first vehicle 220:1 as a virtual representation in a virtual world in response to determining that the virtual gateway is reached and a circuitry 1290 for receiving information relating to navigation of the first remote-controlled vehicle as a virtual vehicle along a virtual second track in the virtual world in response to determining that the virtual gateway is reached.

The arrangement comprising circuitry for object detection 1200 also comprises a circuitry 1295 for implementing or executing other functionality as discussed herein.

The teachings herein thus enable for joining two or more tracks through virtual gateways.

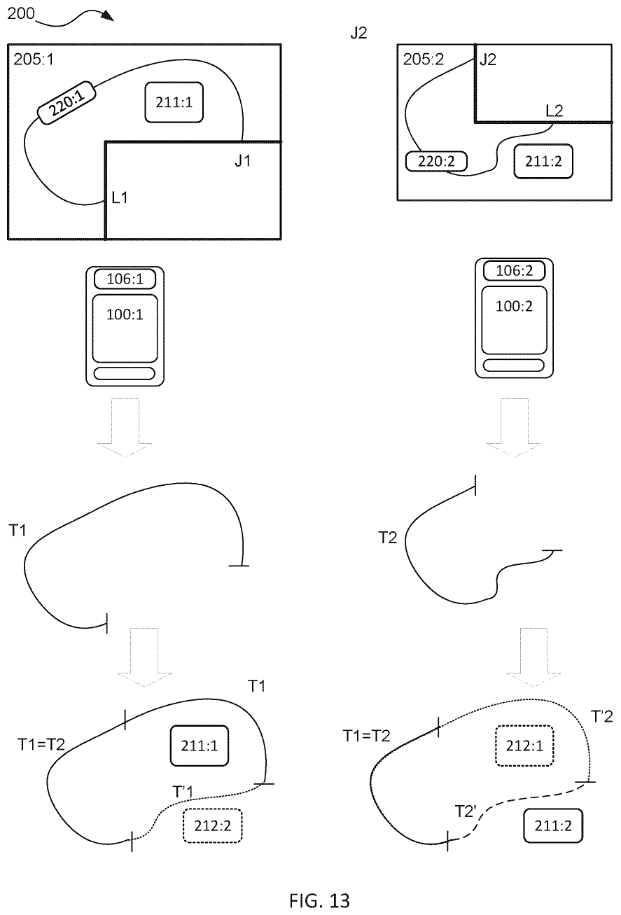

FIG. 13 shows a schematic view of an example embodiment where the manner of aligning tracks and the manner of joining tracks is combined where a first user records a first track T1 and a second user records a second track T2. A portion of tracks T1 and T2 overlaps and shows similarities and may thus be aligned to one another. It should be noted that these portions may not only be portions of a track, but may be a complete track. The aligned portion is indicated in FIG. 13 as T1=T2.

The remaining part of the first track (T1) may be joined to the second track (T′2) by a virtual gateway (indicated by a vertical line) and similarly the remaining part of the second track may be joined to the first track (T′1) by a second virtual gateway. In FIG. 13, the remaining portion of the second track T2 is aligned to enable for a seamless joining as indicated by the dashed lines. The alignment taught herein may thus also be applied when joining tracks.

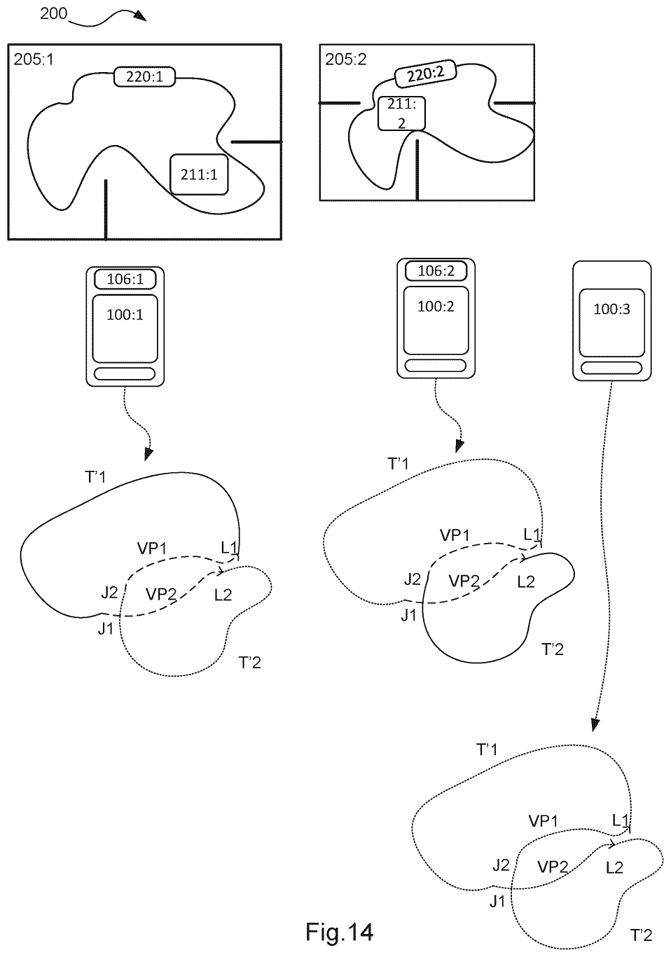

FIG. 14 shows a schematic view of an example embodiment where a third user joins the shared experience, but where the third user only joins in the virtual world. The third user will thus be provided with information regarding the tracks in order to generate the sum of the virtual tracks. In some embodiments, the virtual tracks are generated and distributed by the server 410.

The teachings herein may thus also be used to generate a completely virtual track based on physical tracks for sharing an experience with users at different physical locations having a physical experience.

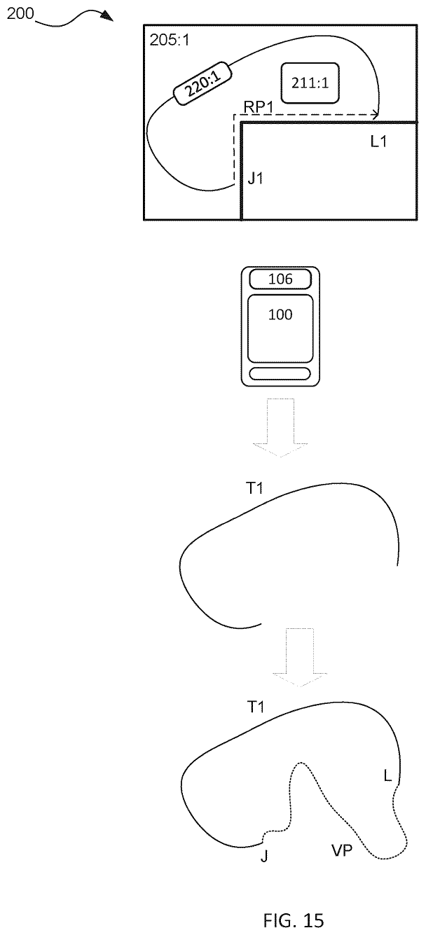

FIG. 15 shows a schematic view of an example embodiment where a single user generates a physical track and combines it with a virtual path, where the physical vehicle returns along a return path while navigating the virtual world.

The teachings herein are thus not restricted for use with multiple users.

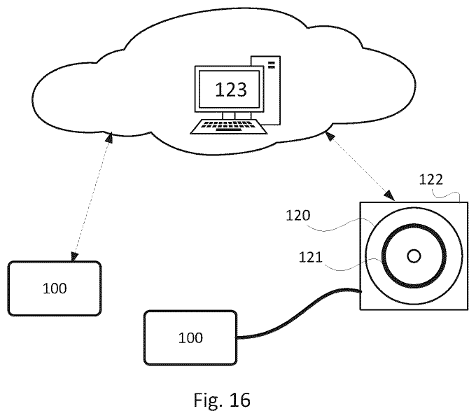

FIG. 16 shows a schematic view of a computer-readable medium 120 carrying computer instructions 121 that when loaded into and executed by a controller of a virtual display arrangement 100 enables the virtual display arrangement 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 16, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the virtual display arrangement 100 for being executed by the controller 101.

The computer disc reader 122 may also or alternatively be connected to (or possibly inserted into) a virtual display arrangement 100 for transferring the computer-readable computer instructions 121 to a controller of the virtual display arrangement (presumably via a memory of the virtual display arrangement 100).

FIG. 16 shows both the situation when a virtual display arrangement 100 receives the computer-readable computer instructions 121 via a server connection and the situation when another virtual display arrangement 100 receives the computer-readable computer instructions 121 through a wired interface. This enables for computer-readable computer instructions 121 being downloaded into a virtual display arrangement 100 thereby enabling the virtual display arrangement 100 to operate according to and implement the invention as disclosed herein.

1. A virtual display arrangement comprising a display device, a communication interface and a controller, wherein
the communication interface is configured to connect with a first remote-controlled vehicle,
the controller is configured to receive user input and to control the first remote-controlled vehicle based on the user input along a track, and
the display device is configured to show the first remote-controlled vehicle being navigated based on the user input along the track, wherein
the communication interface is further configured to connect with a second virtual display arrangement controlling a second remote-controlled vehicle along a second track, and wherein
the controller is configured to:
receive information relating to navigation of the second remote-controlled vehicle along the second track,
display a graphical representation of the second remote-controlled vehicle in the display device at a position relative the first remote-controlled vehicle on the track corresponding to a position of the second remote-controlled vehicle on the second track.

2. The virtual display arrangement according to claim 1, wherein the track is determined based on a first recorded real-world track in an area where the first remote-controlled vehicle is navigated and
wherein the controller is configured to manipulate the navigation of the first remote-controlled vehicle along the first recorded real-world track according to alignment information determined based on the first recorded real-world track and a second recorded real-world track in an area where the second remote-controlled vehicle is navigated.

3. The virtual display arrangement according to claim 2, wherein alignment information relates to adapting the navigation of the first remote-controlled vehicle so as to enable the first remote-controlled vehicle to navigate the first recorded real-world track as if navigating a same common track as the second remote-controlled vehicle, and is determined based on an alignment of the first and second recorded real-world tracks.

4. The virtual display arrangement according to claim 3, wherein alignment information is determined by
identifying differentiating portions between the first real-world track and the second real-world track, the differentiating portions comprising differences,
determine adaptations to enable the first and/or the second remote-controlled vehicles to be navigated through the differentiating portions and thereby cancelling out the differences.

5. The virtual display arrangement according to claim 4, wherein identifying the differentiating portions by
determining that the second recorded real-world track is more irregular than the first real world track and in response thereto providing adaptations for the first remote-controlled vehicle for navigating the first recorded real world track based on the second recorded real world track.

6. The virtual display arrangement according to claim 4, wherein identifying the differentiating portions by
determining that a first portion in the second recorded real-world track is more irregular than a corresponding second portion of the first real world track and in response thereto providing adaptations for the first remote-controlled vehicle for navigating the second portion based on the first portion.

7. The virtual display arrangement according to claim 5, wherein irregularity is determined based on length.

8. The virtual display arrangement according to claim 5, wherein irregularity is determined based on sum of curvatures.

9. The virtual display arrangement according to claim 2, wherein the alignment information is further determined by a scaling operation.

10. The virtual display arrangement according to claim 2, wherein the alignment information is further determined by a rotating operation.

11. The virtual display arrangement according to claim 1, wherein the first recorded real-world track is selected out of one or more first recorded real-world tracks and the second recorded real-world track is selected out of one or more second recorded real-world tracks based on a similarity between the first and the second recorded real-world tracks.

12. The virtual display arrangement according to claim 11, wherein the first recorded real-world track is selected based on
identifying differentiating portions between the first recorded real world track and the second recorded real world track;
identifying objects in the differentiating portions;
indicate the identified objects as objects to be moved; and
record a new version of the first recorded real-world track.

13. The virtual display arrangement according to claim 1, processing is performed by the controller of the virtual display arrangement and wherein the communication interface is configured to receive information representing the second recorded real world track.

14. The virtual display arrangement according to claim 1, processing is performed by the second virtual display arrangement and wherein the communication interface is configured to transmit information representing the first recorded real world track to the second virtual display arrangement and to receive the alignment information from the second virtual display arrangement.

15. The virtual display arrangement according to claim 1, processing is performed by a server and wherein the communication interface is configured to transmit information representing the first recorded real world track to the server and to receive the alignment information from the server.

16. The virtual display arrangement according to claim 1, the display device is configured to show the first remote-controlled vehicle being navigated based on the user input along the track by receiving at least one image of the first remote-controlled vehicle being navigated based on the user input along the track and displaying said at least one image on the display device.

17. The virtual display arrangement according to claim 1, wherein the virtual display arrangement is a smartphone or a tablet computer.

18. The virtual display arrangement according to claim 1, wherein the virtual display arrangement is a head-mounted display device.

19. The virtual display arrangement according to claim 1, wherein the virtual display arrangement is an optical see-through device.

20. The virtual display arrangement according to claim 1, wherein the first remote controlled vehicle is a remote controlled car or a drone.

21. A system comprising a virtual display arrangement according to claim 1 and a server.

22. A method for use in a virtual display arrangement, wherein the method comprises:
connecting with a first remote-controlled vehicle,
receiving user input and controlling the first remote-controlled vehicle based on the user input along a track,
showing the first remote-controlled vehicle being navigated based on the user input along the track,
connecting with a second virtual display arrangement controlling a second remote-controlled vehicle along a second track,
receiving information relating to navigation of the second remote-controlled vehicle along the second track, and
displaying a graphical representation of the second remote-controlled vehicle at a position relative the first remote-controlled vehicle on the track corresponding to a position of the second remote-controlled vehicle on the second track.

23. A non-transitory computer-readable medium carrying computer instructions that when loaded into and executed by a controller of a virtual display arrangement causes the virtual display arrangement to implement a method comprising:
connecting with a first remote-controlled vehicle;
receiving user input and controlling the first remote-controlled vehicle based on the user input along a track;
showing the first remote-controlled vehicle being navigated based on the user input along the track;
connecting with a second virtual display arrangement controlling a second remote-controlled vehicle along a second track;
receiving information relating to navigation of the second remote-controlled vehicle along the second track; and
displaying a graphical representation of the second remote-controlled vehicle at a position relative the first remote-controlled vehicle on the track corresponding to a position of the second remote-controlled vehicle on the second track.

24. (canceled)

25. A virtual display arrangement comprising:
a circuitry for connecting with a first remote-controlled vehicle,
a circuitry for receiving user input and controlling the first remote-controlled vehicle based on the user input along a track,
a circuitry for showing the first remote-controlled vehicle being navigated based on the user input along the track,
a circuitry for connecting with a second virtual display arrangement controlling a second remote-controlled vehicle along a second track,
a circuitry for receiving information relating to navigation of the second remote-controlled vehicle along the second track, and
a circuitry for displaying a graphical representation of the second remote-controlled vehicle at a position relative the first remote-controlled vehicle on the track corresponding to a position of the second remote-controlled vehicle on the second track.
